(19) United States
(12) Patent Application Publication
(10) Pub. No.: US 2025/0336662 A1
(43) Pub. Date: Oct. 30, 2025

(54) Mass Spectrometer

(71) Applicant: SHIMADZU CORPORATION, Kyoto-shi (JP)

(72) Inventors: Roger GILES, Manchester (GB); Alina GILES, Manchester (GB)

(21) Appl. No.: 18/854,709

(22) PCT Filed: Apr. 17, 2023
(86) PCT No.: PCT/JP2023/015357

§ 371 Date: May 28, 2025

(30) Foreign Application Priority Data
Apr. 18, 2022 (WO) PCT/JP2022/018084

(51) Int. Cl. H01J 49/42; H01J 49/06

(52) U.S. Cl. CPC H01J 49/4225; H01J 49/062

(57) ABSTRACT

A mass spectrometer includes: an LIT to trap ions derived from a sample in a trap space extending along a linear axis and eject a part of the ions from the trap space to an outside; an ion guide unit to receive and deliver the ions to a latter stage, the ion guide unit including an ion inlet to receive the ejected ions, an ion outlet to send the received ions and/or ions generated from the received ions to a latter stage, and an ion passage path having a cross-sectional area decreasing as the ions travel from the ion inlet to the ion outlet; a bunching unit to bunch the ejected ions to form an ion bunch and to send the ion bunch to a downstream side; and a mass spectrometry unit to separate and detect, according to a m/z, ions contained in the ion bunch.

### TECHNICAL FIELD

The present invention relates to a mass spectrometer.

### BACKGROUND ART

In recent years, in various fields including drug discovery fields, use of a liquid chromatograph mass spectrometer (LC-MS) using a tandem mass spectrometer as a detector has been rapidly advanced in order to simultaneously and comprehensively perform qualitative analysis or quantitative analysis of a large number of components (compounds) contained in a sample. In particular, a quadrupole-time-of-flight mass spectrometer (Q-TOF mass spectrometer) using a time-of-flight mass separator as a mass separator at the latter stage is effective in identifying and quantifying components contained in a complicated sample.

Conventionally, a data dependent analysis (DDA) method and a data independent analysis (DIA) method are known as methods for comprehensively analyzing a large number of components in a sample by LC-MS equipped with such a tandem mass spectrometer.

In the DDA method, a mass spectrometry which includes no dissociation of ions (this type of analysis may be hereinafter called the “MS1 spectrometry”) is initially performed to acquire a mass spectrum over a predetermined range of mass-to-charge ratio (strictly speaking, this should be noted as “m/z” in italic type, although the term “mass-to-charge ratio” or “m/z” is used in this description according to common practices). Subsequently, one or more ion peaks which satisfy a given condition, such as the signal intensity being equal to or higher than a specific threshold, are selected from the peaks observed in the mass spectrum. Following the mass spectrometry, an MS/MS spectrometry in which an ion or ions corresponding to the selected ion peak or peaks are designated as a precursor ion or ions (hereinafter, referred to as “MS2 spectrometry”) is performed, to acquire an MS/MS spectrum in which a wide variety of product ions are observed.

As is apparent from the above processing procedure, in the DDA method, MS/MS spectrometry is not performed for components that do not meet a given condition even if included in a sample. Therefore, MS/MS spectrum information for some components contained in the sample is not collected, and qualitative determination or quantification is not performed. As the number of components contained in the sample increases, the number of components that cause such analysis failure may also increase.

Although it is conceivable to loosen conditions for selecting precursor ions in order to reduce the number of components that cause analysis failure, this is substantially difficult for the following reasons.

That is, there are often a plurality of candidates for precursor ions corresponding to one component, and the signal intensity is divided into the plurality of precursor ions. In particular, in the quadrupole mass filter, the signal intensity decreases to about one several-th to one tenth depending on the selected mass separation width, and in the MS2 spectrometry in the tandem quadrupole mass spectrometer, the signal intensity of product ions also decreases to the same extent. Therefore, in many cases, the signal intensity at the time of MS2 spectrometry is about one several-th to one several-tenths of the signal intensity at the time of MS1 spectrometry. In order to obtain a signal with sufficient intensity in the MS2 spectrometry, it is necessary to accumulate the signal for a longer time than in the MS1 spectrometry, which makes the MS2 spectrometry longer. On the other hand, in LC-MS, the time during which one component is eluted is limited, and there is a limit to loosening the conditions for selecting precursor ions and increasing the number of precursor ions to be selected under the time restriction.

Thus, the DDA method is insufficient for analyzing a large number of components simultaneously and comprehensively.

On the other hand, in the DIA method, ions having a mass-to-charge ratio included in a window of a predetermined mass-to-charge ratio range are collectively used as precursor ions, and MS/MS spectra of product ions generated from the precursor ions are acquired.

Several techniques have been proposed for the DIA method. In a representative technique of SWATH® (Sequential Window Acquisition of all THeoretical fragment ion spectra mass spectrometry) method, the entire mass-to-charge ratio range to be measured is divided into a plurality of windows each having a predetermined mass-to-charge ratio width. Then, while the plurality of windows are sequentially and individually selected (that is, while a target window is moved stepwise by the predetermined mass-to-charge ratio width), ions whose mass-to-charge ratios are included within the mass-to-charge ratio range of each window are collectively selected as precursor ions, and the product ions generated from those precursor ions are comprehensively scanned to acquire an MS/MS spectrum for each window. In addition, as an improved method of the SWATH method, there is a continuous scanning SWATH method of continuously moving the window for mass selection in the mass separation unit of the first stage.

In the SONAR® method, which is another method of the DIA method, MS/MS spectra are repeatedly acquired while moving a window in a predetermined mass-to-charge ratio range and switching collision energy for collision-induced dissociation (CID) in two stages of high and low. In the SWATH method and the SONAR method, the mass-to-charge ratio width of one window is generally about 5 to 20 Th.

In the DIA method, a series of analyses corresponding to one sample injection in LC-MS are conducted, and the MS/MS spectrum data for all precursor ions is attempted to acquire. Theoretically in the DIA method, it is possible to collect MS/MS spectrum information for all components contained in a sample. However, usually, peaks of product ions derived from different precursor ions are observed in an MS/MS spectrum. That is, an MS/MS spectrum includes product ion information corresponding to different components in a mixed state. Therefore, in order to separate such mixed information into product ion information for each component, complicated and lengthy arithmetic processing is required.

In a case where the number of components contained in a sample is very large, or in a case where there are a large number of components having similar chemical structures, the MS/MS spectrum becomes complicated, and product ion information for each individual component may not be able to be properly obtained. In those cases, the accuracy in component identification deteriorates. For avoiding the problem, it is conceivable to reduce the number of precursor ions included in one window by narrowing the width of the window.

However, in the DIA method, ions outside of every window are discarded. Thus, the narrower the width of the window, the lower the utilization efficiency of ions. For example, when the width of the window is set at 1 Da (which is much narrower than that generally used) while the mass-to-charge ratio range to be measured is 1000 Da, the duty cycle, which indicates the ion utilization efficiency, is only 1/1000, that is, 0.1%. Even if the width of a window is set at 20 Da which is generally used, the duty cycle is 20/1000, that is, about 2%. Such a low duty cycle results in a decrease in sensitivity of the MS/MS spectrum.

In summary, in the DIA method, there is a trade-off relationship between the high ion selectivity for avoiding the complexity of arithmetic processing and the small ion loss in selecting precursor ions. Therefore, it is necessary to make an appropriate compromise on these opposing elements. The point is that in order to ensure the accuracy of identification and quantification for a complex sample, the sensitivity needs to be sacrificed to some extent, and conversely, in order to improve the sensitivity for a trace sample, the accuracy of identification and quantification for a complex sample needs to be sacrificed to some extent. In addition, in order to analyze MS/MS spectrum data in the DIA method, there is also a problem that an advanced data analysis method using a complex software tool and a comprehensive mass spectrum library is required.

### CITATION LIST

### Patent Literature

Patent Literature 1: WO 2020/109091 A
Patent Literature 2: WO 2018/114442 A
Patent Literature 3: U.S. Pat. No. 7,342,224 B
Patent Literature 4: US 2015/0041639 A
Patent Literature 5: US 2004/0222369 A
Patent Literature 6: US 2010/0237237 A
Patent Literature 7: U.S. Pat. No. 7,193,207 B
Patent Literature 8: U.S. Pat. No. 8,809,770 B

### Non Patent Literature

Non Patent Literature 1: J. Mitchell Wells, Scott A. McLuckey, “Collision-Induced Dissociation (CID) of Peptides and Proteins”, Biological Mass Spectrometry, 10.1016/S0076-6879 (05) 02005-7, 148-185, 2005
Non Patent Literature 2: Li Ding and 4 others, “A digital ion trap mass spectrometer coupled with atmospheric pressure ion sources”, Journal of Mass Spectrometry, 2004, Vol.

39, pp. 471-484

### SUMMARY OF INVENTION

### Technical Problem

In a two-dimensional (2D) mass spectrometer capable of performing MS1 spectrometry and MS2 spectrometry substantially in parallel, it is a major issue to be able to cope with the problems of the conventional DDA method and DIA method as described above.

The present inventors has been engaged in the development of a 2D mass spectrometer for many years. In relation to such development, the present inventors has already proposed a novel 2D mass spectrometer including a linear ion trap, a bunching ion guide, a time-of-flight mass spectrometry unit and other components in Patent Literature 1 and other literatures. In addition, the present inventors has already proposed a bunching ion guide used for the device in Patent Literature 2 and other literature prior to Patent Literature 1.

In the novel 2D mass spectrometer disclosed in Patent Literature 1, it is possible to use, as a first-stage mass separator, a linear ion trap (LIT) that mass-selectively ejects ions in a direction orthogonal to an axis of the mass separator. In the LIT, ions are trapped in an internal space, and ions having a mass-to-charge ratio within a specific mass-to-charge ratio range can be selectively ejected from the internal space. Therefore, in the novel 2D mass spectrometer described above, ions other than those transported to the latter stage are not immediately discarded as in a case where a quadrupole mass filter is used as the first-stage mass separator, which is advantageous for increasing the utilization efficiency of ions. In addition, as is well known, generally, the LIT has a larger charge capacity than the three-dimensional quadrupole ion trap, and can accumulate a larger amount of ions in the internal space. Therefore, it is also advantageous to increase the amount of ions to be subjected to mass spectrometry to increase the spectrometry sensitivity.

In addition, in the novel 2D mass spectrometer, precursor ions ejected from the LIT are bunched, or grouped together, to form one ion bunch, and a plurality of ion bunches are transported one by one. Then ions of every ion bunch are dissociated by CID or the like while being transported, and the product ions generated by dissociation of ions in every ion bunch can be sequentially subjected to mass spectrometry by the time-of-flight mass spectrometry unit. As a result, in the novel 2D mass spectrometer, precursor ions intermittently ejected one after another from the LIT and product ions derived from the precursor ions can be efficiently analyzed while avoiding mixture of precursor ions and product ions ejected at different time points.

Throughput (utilization efficiency) and spectrometry sensitivity of ions of a mass spectrometer are improved by using an LIT having larger charge capacity. As is well known, the charge capacity of an LIT that ejects ions in the radial direction as described above depends on the axial length of the rod electrodes for trapping ions. Therefore, in order to improve the throughput and spectrometry sensitivity of ions in an LIT, it is desirable that the rod electrodes whose length is extended in the axial direction is used, and the ion ejection hole for ejecting ions in the radial direction is also long in the axial direction. However, when such a configuration is adopted, the size of the ion group ejected from the ion ejection hole in the plane orthogonal to the traveling direction is elongated in the axial direction of the LIT, and may be larger than the ion receivable size of the ion inlet of the bunching ion guide disposed on the downstream side of the ion flow.

Patent Literature 1 discloses that a multipole RF ion guide is disposed between an LIT and a bunching ion guide, and ions ejected from the LIT are converged by the RF ion guide and introduced into the bunching ion guide. However, in a general multipole RF ion guide, it is difficult to efficiently gather spatially spread ions, and further, to reduce the cross-sectional area of the ion flow or to adjust the shape of the ion flow so as to conform to the cross-sectional area of the ion inlet of the bunching ion guide disposed downstream.

Patent Literature 3 discloses a tandem mass spectrometer including an LIT that ejects ions in a radial direction, a collision cell that dissociates the ions by CID, and a time-of-flight mass separation unit of an orthogonal acceleration system. In this mass spectrometer, ions derived from a sample component are first accumulated in an LIT, and then a mass scan is performed so that ions having a specific mass-to-charge ratio are successively selected in the LIT, ejected in the radial direction and introduced into the collision cell. The collision cell dissociates at least a part of the introduced ions to generate product ions. The generated product ions (and ions that have not dissociated) are separated according to the mass-to-charge ratio in the time-of-flight mass separator and detected at a high speed.

In the mass spectrometer described in Patent Literature 3, an ion flow having a cross-sectional shape elongated in the axial direction of the radial ejection-type LIT is ejected from the LIT and enters the collision cell. Therefore, in the collision cell, such an ion optical system is disposed that can trap and dissociate ions using a DC electric field and an RF electric field and converge and send product ions generated by the dissociation from the collision cell. In the mass spectrometer described in Patent Literature 3, product ions generated from ions that have entered the collision cell are ejected from the collision cell within 0.5 to 3 msec and sent to the latter stage.

In order to solve the above-described problem in the novel 2D mass spectrometer, the present inventors considered using an ion optical system as disclosed in Patent Literature 3. However, such an ion optical system does not satisfy at least a temporal requirement.

That is, in the above-described novel 2D mass spectrometer, the time dependence of the ions ejected from the LIT should be substantially maintained at the stage of reaching the bunch forming portion forming an ion bunch in the bunching ion guide. For example, when precursor ions having a specific mass-to-charge ratio within a fraction of the mass-to-charge ratio range of 1 Th are ejected from the LIT within a time of 0.25 msec, both the precursor ions and the product ions generated from the precursor ions should reach the inlet of the bunching ion guide within a time of the order of 0.25 msec, which is substantially the same as at the time of ejection. If this temporal requirement is not satisfied, it may not be ensured that all of the precursor ions ejected at one time and the product ions generated from those precursor ions are accommodated in one potential well as one ion bunch. The ion transport time that can be realized by the ion optical system proposed in Patent Literature 3 is too long, and the time requirement in the ion optical system required in the novel 2D mass spectrometer cannot be satisfied.

The present invention has been made to solve the above problems, and a main object of the present invention is to provide a mass spectrometer capable of improving ion throughput and spectrometry sensitivity by efficiently delivering ions ejected from an LIT having a large charge capacity to a bunching ion guide in a short transport time, and further capable of improving spectrometry sensitivity while ensuring completeness of spectrometry.

### Solution to Problem

In one mode of a mass spectrometer according to the present invention made to solve the above problems, a mass spectrometer includes:
a linear ion trap configured to trap ions derived from a sample in a trap space extending along a linear axis and eject a part of the ions from the trap space to the outside;
an ion guide unit configured to receive the ions ejected from the linear ion trap and deliver the ions to a latter stage, the ion guide unit including an ion inlet configured to receive the ejected ions, an ion outlet configured to send the received ions and/or ions generated from the received ions to a latter stage, and an ion passage path having a cross-sectional area decreasing as the ions travel from the ion inlet to the ion outlet;
a bunching unit configured to bunch the ions ejected from the ion outlet of the ion guide unit to form an ion bunch and to send the ion bunch to a downstream side; and
a mass spectrometry unit configured to separate and detect, according to a mass-to-charge ratio, ions contained in the ion bunch formed and sent by the bunching unit.

In the mass spectrometer of the above mode, the linear ion trap may be configured to trap the ions derived from the sample in the trap space extending along the linear axis and eject a part of the ions in a direction substantially orthogonal to the axis through an ejection hole having an elongated shape in a direction of the axis, and the ion guide unit is configured such that a size in a longitudinal direction of the ejection hole of an inlet-side cross section of the ion passage path is larger than a size in the longitudinal direction of the ejection hole of an outlet-side cross section of the ion passage path.

In the mass spectrometer of the above mode, the linear ion trap may be configured to trap the ions derived from the sample in the trap space extending along the linear axis and eject a part of the ions in a direction parallel to the axis through an ejection hole provided on the axis.

### Advantageous Effects of Invention

The mass spectrometer of the above mode according to the present invention includes an ion guide unit between the linear ion trap and the bunching unit, the ion guide unit being configured to receive ions ejected through the ejection hole of the linear ion trap and deliver the ions to the bunching unit at the latter stage. The ion guide unit has an ion passage path between an ion inlet and an ion outlet, the cross-sectional area of which decreases as ions travel. Therefore, an ion group ejected from the linear ion trap is introduced into the ion passage path of the ion guide unit with a small loss. Then, as the ion group travels in the ion passage path, the cross-sectional area in the plane orthogonal to the axis decreases, that is, converged, and the ion group exits the ion passage path in a state where the cross-sectional area decreases and is sent to the bunching unit.

Thus, in the above mode of the mass spectrometer according to the present invention, a large number of ions ejected from the linear ion trap can be delivered to the bunching unit with a small loss. In addition, since the ion guide unit does not perform an operation that leads to a time delay of ions, the ions ejected from the linear ion trap can be delivered to the bunching unit in a short time while maintaining the mass resolution of the ions. Then, in the bunching unit, one ion bunch including the large number of ions is formed, and in the mass spectrometry unit, mass spectrometry for the large number of ions contained in the one ion bunch can be performed in a state of not being mixed with other ion bunches.

Therefore, according to the above mode of the mass spectrometer according to the present invention, it is possible to enhance the spectrometry sensitivity while improving the throughput of ions. As a result, the sensitivity of the spectrometry can be improved while ensuring the completeness of the spectrometry. In addition, since it is possible to acquire a mass spectrum with high purity in which ions having a specific mass-to-charge ratio and product ions derived from the ions can be observed, it is possible to avoid complicated data processing of mass spectrum data, and it is possible to perform qualitative analysis, quantitative analysis, structural analysis, and the like based on a mass spectrum with higher accuracy.

### BRIEF DESCRIPTION OF DRAWINGS

FIG. 1 An overall configuration diagram of a mass spectrometer as one embodiment of the present invention.

FIG. 2 A configuration diagram centering on a dual LIT and an ion focusing guide in the mass spectrometer of the present embodiment.

FIG. 3 A schematic cross-sectional configuration diagram of a second LIT and the ion focusing guide in the mass spectrometer of the present embodiment.

FIG. 4 Configuration diagrams of a bunching ion guide in the mass spectrometer of the present embodiment.

FIG. 5 A configuration diagram of a power supply unit of the second LIT in the mass spectrometer of the present embodiment.

FIG. 6 Voltage waveform diagrams of voltage applied from the power supply unit illustrated in FIG. 5 to the second LIT.

FIG. 7 A diagram illustrating an example of an electrode shape of the ion focusing guide.

FIG. 8 A diagram illustrating an example of an electrode shape of the ion focusing guide.

FIG. 9 Diagrams illustrating an example of an electrode shape of the ion focusing guide.

FIG. 10 A diagram illustrating an example of an electrode shape of the ion focusing guide.

FIG. 11 Schematic diagrams illustrating gas pressure distributions in the ion focusing guide and the bunching ion guide of the mass spectrometer of the present embodiment.

FIG. 12 A diagram illustrating another example of the ion focusing guide in the mass spectrometer of the present embodiment.

FIG. 13 A diagram illustrating another example of the ion focusing guide in the mass spectrometer of the present embodiment.

FIG. 14 Explanatory diagrams of an operation of the dual LIT in the mass spectrometer of the present embodiment.

FIG. 15 A scan line diagram illustrating the relationship between the elapsed time in a mass scan by multiple dipole AC excitation and the mass-to-charge ratio of excitation.

FIG. 16 A diagram illustrating an example of a model of an LIT and an ion focusing guide for simulating behavior of ions.

FIG. 17 Diagrams illustrating an example of a voltage waveform at the time of forming a bunching.

FIG. 18 Diagrams illustrating an example of a voltage waveform of ion bunch transport.

FIG. 19 Diagrams illustrating temporal changes in ionic intensity obtained by simulation.

FIG. 20 A diagram illustrating a modification of the ion focusing guide illustrated in FIG. 12.

FIG. 21 A diagram illustrating an example of a gas pressure distribution on an ion optical axis in a case where the ion focusing guide having the configuration illustrated in FIG. 20 is used.

FIG. 22 Diagrams illustrating an example of a potential distribution on an ion optical axis in the vicinity of a connection region between the ion focusing guide and the bunching ion guide.

FIG. 23 Diagrams illustrating an example of the relationship between the mass-to-charge ratio of ions and the ion passage efficiency when the direct-current potential in the connection region between the ion focusing guide and the bunching ion guide is lowered.

FIG. 24 An overall configuration diagram of a mass spectrometer according to another embodiment of the present invention.

### DESCRIPTION OF EMBODIMENTS

Hereinafter, an embodiment of a mass spectrometer according to the present invention will be described in detail with reference to the drawings.

### First Embodiment

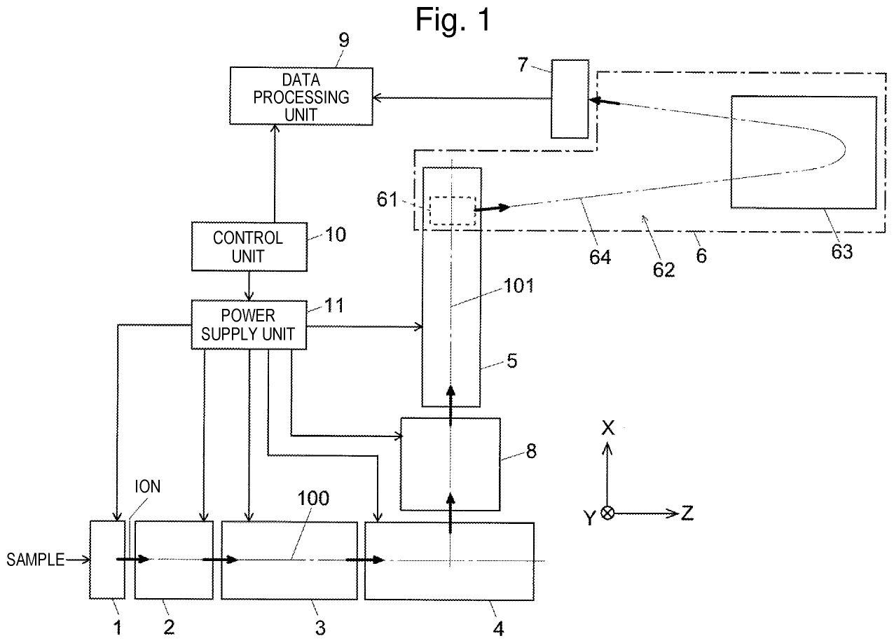

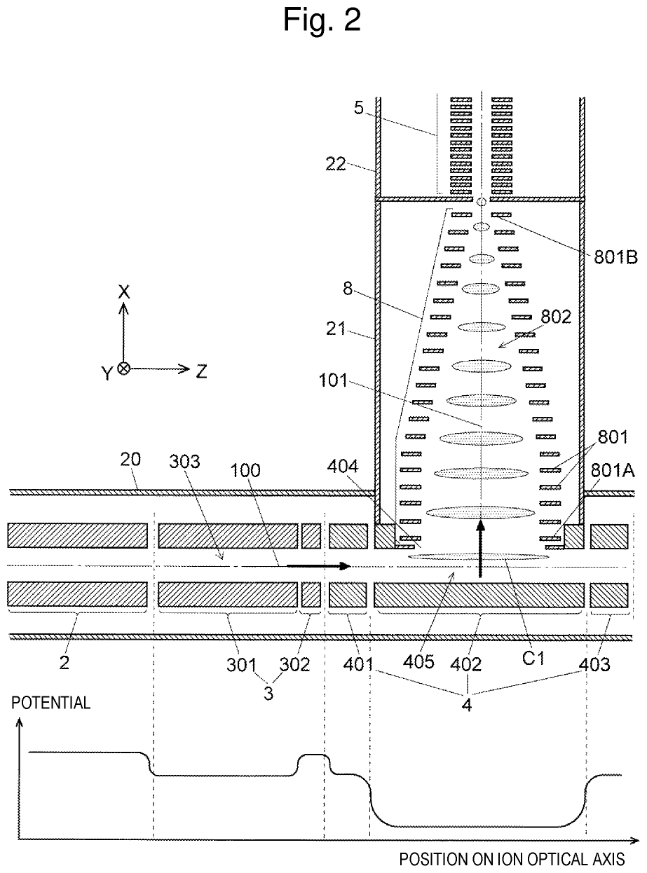

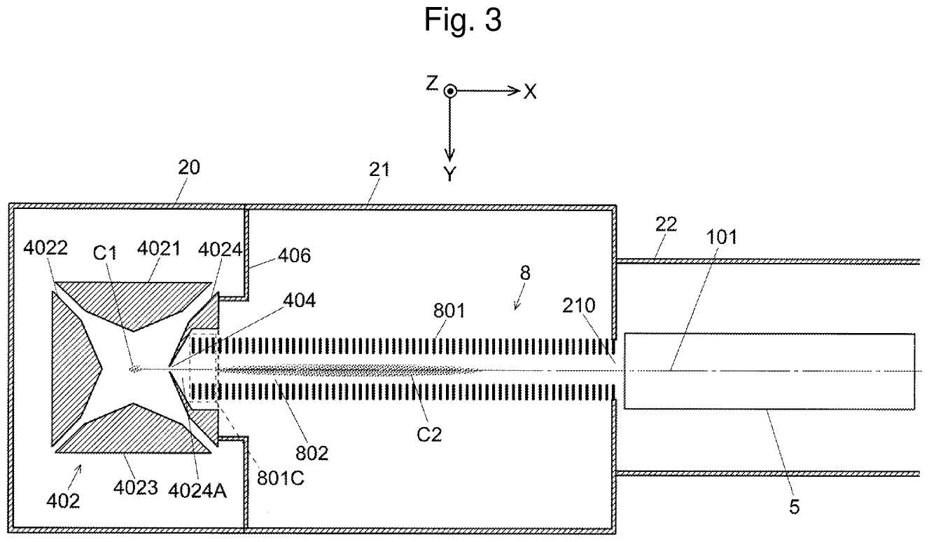

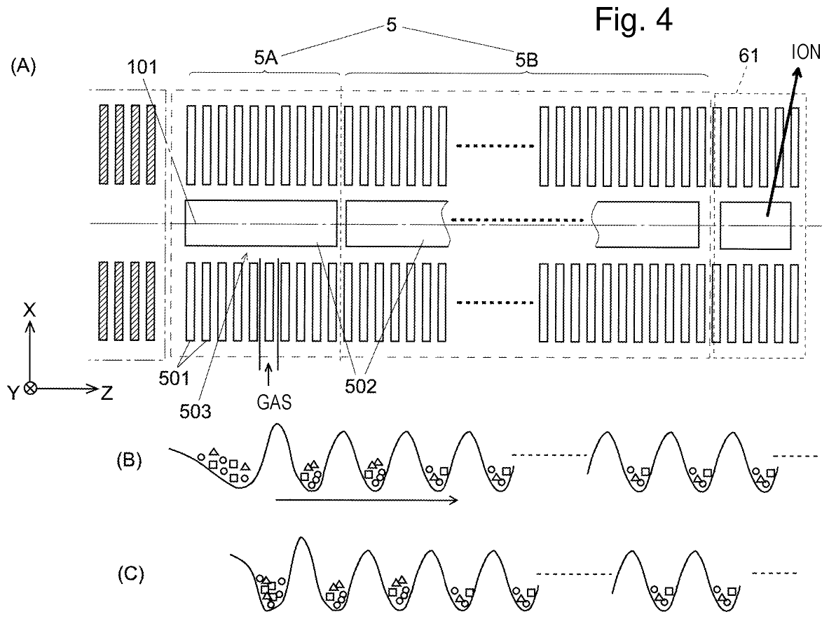

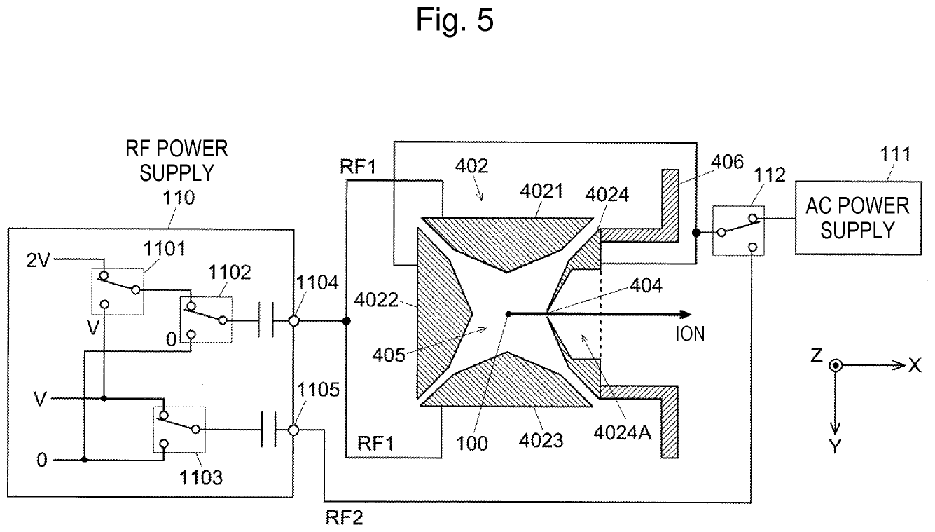

FIG. 1 is an overall configuration diagram of a first embodiment of a mass spectrometer according to the present invention. FIG. 2 is a configuration diagram centering on a dual LIT and an ion focusing guide in the mass spectrometer of the first embodiment. FIG. 3 is a schematic cross-sectional view taken along a plane including an axis (ion optical axis) 101 in FIG. 2. FIG. 4 includes configuration diagrams of a bunching ion guide in the mass spectrometer of the first embodiment. FIG. 5 is a configuration diagram of a power supply unit of a second LIT in the mass spectrometer of the present embodiment.

This mass spectrometer includes an ion source 1, an ion accumulation unit 2, a first LIT 3, a second LIT 4, an ion focusing guide 8, a bunching ion guide 5, an orthogonal acceleration TOF analysis unit 6, an ion detection unit 7, a data processing unit 9, a power supply unit 11, and a control unit 10. Here, although not illustrated, at least other components other than the ion source 1 are accommodated in a chamber maintained in an appropriate vacuum atmosphere. For convenience of explanation, three axes of X, Y and Z which are orthogonal to each other are illustrated in FIG. 1 and some diagrams described later.

The ion source 1 ionizes components (compounds) contained in the introduced sample. The ionization method in the ion source 1 is not particularly limited. When a liquid chromatograph (LC) is connected to the preceding stage of the mass spectrometer, the ion source 1 is an ion source using an atmospheric pressure ionization method typified by an electrospray ionization (ESI) method. In this case, since the ion source is disposed in the atmospheric pressure atmosphere and the ion accumulation unit 2 and the latter units are disposed in the vacuum chamber, an interface mechanism for transporting ions generated in the ion source 1 to the ion accumulation unit 2 is additionally provided while separating the atmospheric pressure region and the vacuum region from each other.

The ion accumulation unit 2 is a kind of buffer that accumulates all ions sent from the ion source 1 and sends the accumulated ions to the latter stage. As the ion accumulation unit 2, an LIT or the like can be used.

The first LIT 3 is an LIT that mass-selectively ejects ions in the direction of an axis 100 (Z-axis direction in this example). On the other hand, the second LIT 4 is an LIT that mass-selectively ejects ions in the radial direction (X-axis direction in this example) orthogonal to the axis 100. The first LIT 3 and the second LIT 4 constitute a dual LIT. In the following description, an LIT that mass-selectively and axially ejects ions may be referred to as mass selective axial ejection-type LIT or an MSAE-type LIT, and an LIT that mass-selectively and radially ejects ions may be referred to as mass selective radial ejection-type LIT or an MSRE-type LIT.

The ion focusing guide 8 is an ion optical system that efficiently gathers ions ejected from the second LIT 4 with a large cross-sectional area (cross-sectional area on a plane orthogonal to an axis 101) and sends the ions to the bunching ion guide 5 while reducing the cross-sectional area. The ion focusing guide 8 also has a function of dissociating ions by the CID in the middle of the transport to generate product ions.

The bunching ion guide 5 forms an ion bunch including ions ejected at one time and product ions generated from the ions while substantially maintaining the mass resolution of the ions at the time point of ejection from the second LIT 4. In addition, the bunching ion guide 5 transports the formed individual ion bunches in a state of being separated from other ion bunches. The orthogonal acceleration TOF analysis unit 6 includes an orthogonal acceleration portion 61 and a flight space 62 including an ion reflection portion 63.

An example of a mass spectrometry operation in this mass spectrometer will be schematically described.

The ion source 1 ionizes components contained in a continuously introduced sample one after another, for example. The ion accumulation unit 2 temporarily accumulates the ions sent from the ion source 1. In the ion accumulation unit 2, all ions having a wide mass-to-charge ratio range over at least the entire mass-to-charge ratio range to be analyzed can be accumulated. All ions pulse-ejected from the ion accumulation unit 2 are introduced into the first LIT 3. Every time the mass scan in the first LIT 3 ends, that is, every time all the ions in the predetermined mass-to-charge ratio range trapped in the first LIT 3 are discharged to the second LIT 4, the entire amount of ions accumulated in the ion accumulation unit 2 at that time point is pulse-ejected and introduced into the first LIT 3. The transfer of ions from the ion accumulation unit 2 to the first LIT 3 is performed at high speed, and is completed within 1 msec, for example. After the entire amount of ions accumulated in the ion accumulation unit 2 is transferred to the first LIT 3, the ion accumulation unit 2 continues to accumulate ions.

The ions ejected from the ion accumulation unit 2 are trapped by the first LIT 3 and held in the internal space of the first LIT 3. While trapping ions, the first LIT 3 selectively ejects some of the ions, specifically ions included in a mass-to-charge ratio range having a predetermined first mass-to-charge ratio width, in the axial direction at a predetermined timing. The ejected ions are introduced into the second LIT 4 of the next stage and trapped and held in the internal space of the second LIT 4. While trapping ions, the second LIT 4 selectively ejects some of the ions, specifically, ions included in a mass-to-charge ratio range having a predetermined second mass-to-charge ratio width narrower than the first mass-to-charge ratio width in the radial direction at a predetermined timing. As will be described later, the second mass-to-charge ratio width is usually considerably narrow, for example, about 1 Da or less to at most several Da.

The ions ejected from the second LIT 4 are introduced into the bunching ion guide 5 through the ion focusing guide 8. At least some ions are dissociated on the way, and product ions are generated. The bunching ion guide 5 receives the ions transported by the ion focusing guide 8, and bunches the ions ejected at one time and product ions generated from the ions to form one ion bunch. The bunching ion guide 5 sequentially conveys the ion bunch so that the ion bunch does not mix with other ion bunches, and delivers the ion bunch to the orthogonal acceleration portion 61.

The orthogonal acceleration portion 61 receives the ion bunch from the bunching ion guide 5, and accelerates all the ions contained in one ion bunch at once in a direction substantially orthogonal to the entering axis (X-axis direction in this example). The ions ejected from the orthogonal acceleration portion 61 fly in the flight space 62 along a flight trajectory 64 while being reflected by the ion reflection portion 63, and reach the ion detection unit 7. Since each ion flies at a velocity corresponding to the mass-to-charge ratio, the ions are separated according to the mass-to-charge ratio during flight, and ions having different mass-to-charge ratios reach the ion detection unit 7 with a time difference.

The ion detection unit 7 generates ionic intensity signals corresponding to the amount of ions which have reached the ion detection unit 7, and sends the signals to the data processing unit 9. The flight time of each ion starting from the time point at which the ion is ejected from the orthogonal acceleration portion 61 corresponds to the mass-to-charge ratio of the ion. The data processing unit 9 generates a mass spectrum (MS2 spectrum) indicating the relationship between the mass-to-charge ratio and the ionic intensity signal on the basis of the temporal change in the ionic intensity signal received from the ion detection unit 7.

The behavior of ions in each unit as described above is controlled by the voltage applied to each unit from the power supply unit 11 controlled by the control unit 10. The control unit 10 is typically a computer, and operates the power supply unit 11 according to a preset program and a parameter input through an operation unit (not illustrated).

Next, a characteristic configuration and operation of the mass spectrometer will be described in detail.

### <Configuration and Operation of Dual LIT>

The first LIT 3 is an MSAE-type LIT. For example, when the ions ejected from the first LIT 3 are trapped in the second LIT 4, it is important to reduce the loss of the ions during the transfer of the ions as small as possible and to increase the trapping efficiency of the ions at the transfer destination as much as possible.

As illustrated in FIG. 2, the first LIT 3 includes a main rod portion 301 and a post-rod portion 302. Both the main rod portion 301 and the post-rod portion 302 have a quadrupole rod structure in which four rod electrodes extending in the direction of the axis (ion optical axis) 100 (Z-axis direction) are disposed around the axis 100 so as to surround the axis 100. A radio-frequency (RF) voltage RF1 for confining ions in the internal space 303 is applied to both the rod electrode of the main rod portion 301 and the rod electrode of the post-rod portion 302. In addition, an AC voltage AC1 different from the RF voltage RF1 is applied to a part of the rod electrode of the main rod portion 301. Furthermore, an AC voltage AC3 different from the RF voltage RF1 may also be applied to a part of the rod electrode of the post-rod portion 302. These AC voltages AC1 and AC3 are voltages for resonantly exciting ions mass-selectively.

In order to form a potential barrier in the vicinity of the outlet end (the right end portion in FIG. 2) of the first LIT 3, an appropriate DC barrier voltage DC1 is applied to the rod electrode of the post-rod portion 302. The DC barrier voltage DC1 is a relative voltage based on an appropriate DC bias voltage (0 V in some cases) applied to the rod electrode of the main rod portion 301.

As illustrated in FIG. 2, the second LIT 4 includes a pre-rod portion 401, a main rod portion 402, and a post-rod portion 403 divided into three in the direction of the axis 100. Each of the pre-rod portion 401, the main rod portion 402, and the post-rod portion 403 has a quadrupole rod structure in which four rod electrodes extending in the direction of the axis 100 are disposed around the axis 100 so as to surround the axis 100. As illustrated in FIGS. 3 and 5, in one rod electrode (hereinafter, this electrode may be referred to as “ion ejection rod electrode”) 4024 of the four rod electrodes 4021 to 4024 of the main rod portion 402, a slit-shaped opening elongated in the direction of the axis 100 is formed as an ion ejection hole 404.

This dual LIT may operate in the following order:
(Step S1) Ions generated from the sample are introduced from the ion source 1 into the ion accumulation unit 2.
(Step S2) The ions accumulated in the ion accumulation unit 2 are introduced into the first LIT 3 at a predetermined timing. In this step, mass selection of ions is not performed, and all ions accumulated in the ion accumulation unit 2 move to the first LIT 3.
(Step S3) After the ions are transferred to the first LIT 3, a simultaneous mass scan is started in the first LIT 3 and the second LIT 4.
(Step S4) Ions generated by the ion source 1 are accumulated in the ion accumulation unit 2 during a period of the simultaneous mass scan.
(Step S5) When the simultaneous mass scan in the dual LIT is completed, the process returns to step S2, and the ions newly accumulated in the ion accumulation unit 2 are transferred from the ion accumulation unit 2 to the first LIT 3 in a short time.

The above cycle is continuously repeated in liquid chromatograph mass spectrometry (LC/MS), for example, during a period until all the components in the sample injected by the liquid chromatograph are introduced into the mass spectrometer.

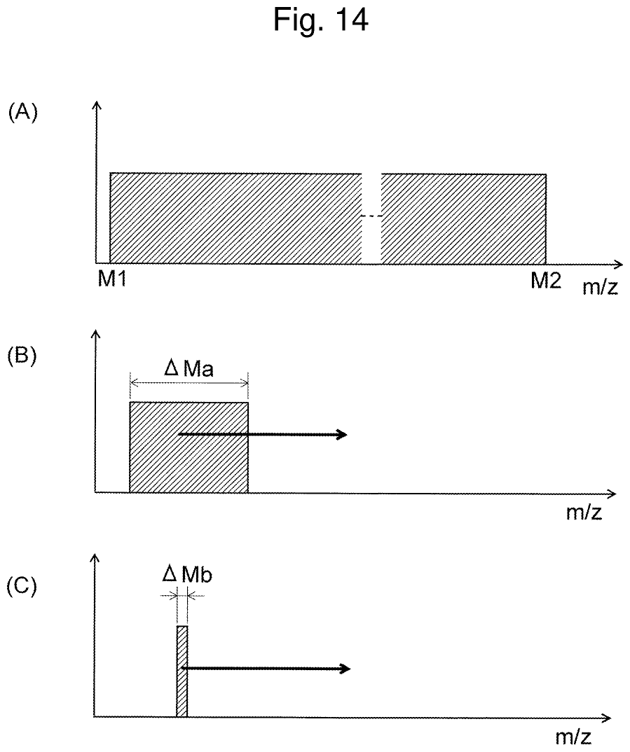

FIG. 14 includes conceptual diagrams of the simultaneous mass scan in step S3. FIG. 14A illustrates a mass-to-charge ratio range of ions trapped in the first LIT 3 at the time point immediately after the ion transfer from the ion accumulation unit 2. In this example, ions having a mass-to-charge ratio in the range of the minimum mass-to-charge ratio value M1 to the maximum mass-to-charge ratio value M2 are trapped in the first LIT 3. However, this merely means that ions in this mass-to-charge ratio range can be present, and does not necessarily mean that all ions are actually present.

FIG. 14(B) illustrates the mass-to-charge ratio range of ions ejected from the first LIT 3 during the simultaneous mass scan. The width (first mass-to-charge ratio width) of the mass-to-charge ratio range of the ejected ions is ΔMa, and as indicated by a rightward arrow, a mass scan is performed so that the mass-to-charge ratio range moves while this mass-to-charge ratio width is maintained. On the other hand, FIG. 14(C) illustrates the mass-to-charge ratio range of ions ejected from the second LIT 4 during the simultaneous mass scan. The width (second mass-to-charge ratio width) of the mass-to-charge ratio range of the ejected ions is ΔMb narrower than ΔMa, and as indicated by a rightward arrow, a mass scan is performed so that the mass-to-charge ratio range moves while this mass-to-charge ratio width is maintained.

As described above, in the simultaneous mass scan, the first LIT 3 and the second LIT 4 are simultaneously driven such that ions having a mass-to-charge ratio respectively included in a predetermined mass-to-charge ratio range are ejected and such that the mass-to-charge ratio range moves, that is, the mass scan is executed. At this time, the simultaneous mass scan is performed such that a predetermined difference, that is, a mass offset occurs between the mass-to-charge ratio range of ions ejected in the mass scan in the first LIT 3 and the mass-to-charge ratio range of ions ejected in the mass scan in the second LIT 4.

That is, the mass scan in the first LIT 3 is performed to eject ions having a higher mass-to-charge ratio than the mass scan in the second LIT 4 at any time point during the simultaneous mass scan. This is because, after a certain ion is transferred from the first LIT 3 to the second LIT 4, the ion contacts the buffer gas inside the second LIT 4 to secure a time required for cooling. Therefore, the magnitude of the mass offset is desirably determined according to the pressure of the buffer gas present in an internal space 405 of the second LIT 4, and is preferably longer than the time required to cool the ions so as to be in thermal equilibrium with the buffer gas present in the internal space 405 of the second LIT 4. Note that the start mass-to-charge ratio and the end mass-to-charge ratio of each mass scan can be appropriately selected according to the type or the like of the sample to be analyzed.

As described above, since the ion ejection hole 404 has an elongated shape in the direction of the axis 100, as indicated by reference numeral C1 in FIGS. 2 and 3, ions are ejected as an ion group having a substantially rectangular cross section that is long in the direction of the axis 100 (Z-axis direction) and short in the direction orthogonal to both the axes 100 and 101 (Y-axis direction). In this configuration, even if the main rod portion 402 is lengthened in order to increase the charge capacity, desired ions among the ions trapped in the internal space 405 can be ejected substantially all at once. Therefore, it is possible to reduce the variation in the ejection timing of ions ejected at one time.

If a single LIT that ejects ions in the radial direction is used instead of a dual LIT, all ions are trapped in the internal space of the LIT at the time point of starting mass scan. In order to ensure good spectrometry performance, it is necessary to set the total charge amount of ions accumulated in the LIT to a certain threshold value or less. In order to accurately estimate the space charge limit in the LIT, the description of Patent Literature 4 can be utilized. According to Patent Literature 4, the space charge limit due to the ion density in the internal space of the LIT is 460 charge/mm³. This space charge limit is defined as the charge density such that the mass shift in the resulting mass spectrum is 0.1 Da. That is, when the scan speed is 1 Da/msec, the ion ejection is delayed by 0.1 msec. In this example, it is assumed that the axial length of the ion cloud formed by the ions is 40 mm, which corresponds to the fact that the threshold of the total charge is 1.2×10⁴. Therefore, in the case of a single LIT, signals of up to 1.2×10⁴ charges are reflected in one mass spectrum, and the throughput of ions is up to 6×10³/sec.

On the other hand, in the dual LIT described above, only a part of the ions to be analyzed are trapped by the second LIT 4 at the start of the mass scan. Then, many ions are supplied from the first LIT 3 to the second LIT 4 at a required timing. Therefore, the number of charges that can be processed in the second LIT 4 significantly increases. As an example, since the threshold of the total charge amount in the second LIT 4 increases by (1800/5) times, the threshold of the total charge amount becomes 4×10⁶, and the throughput of the ions increases to 2×10⁶/sec. As described above, by using the dual LIT, the throughput of ions is greatly improved as compared with the case of the single LIT.

### <Adoption of Post-rod Portion in First LIT>

One of the structural features of the first LIT 3 that is the MSAE-type LIT is that the aperture electrode provided at the end portion of the LIT in the device described in Patent Literature 4 or the like is replaced with the short post-rod portion 302 extending in the direction of the axis 100. In order to form a potential barrier in the vicinity of the end portion of the first LIT 3, a DC barrier voltage is applied to the rod electrode of the post-rod portion 302. The reason for adopting such a configuration is as follows.

The present inventors have noticed that the theory of operation of MSAE-type LITs disclosed in Patent Literature 4 and other literatures referred to in Patent Literature 4 is incomplete. The mass-selective axial ion ejection operation in the LIT in the device disclosed in Patent Literature 4 or a general device is achieved by radial resonant excitation of ions by a dipole AC excitation electric field or a quadrupole excitation electric field corresponding to a secular frequency of ions held in the LIT. When a target ion having a predetermined mass-to-charge ratio is resonantly excited in the radial direction, the ion can climb over a potential barrier formed by a barrier voltage applied to an aperture electrode provided at one end portion of the LIT, and mass-selectively exit from the LIT in the axial direction.

The present inventors conducted a simulation for examining the behavior of ions for the device described in Patent Literature 4. The results showed that in the device, ions are ejected from the LIT with a wide range of energy in the axial and radial directions, respectively, resulting in a large loss. As disclosed in Patent Literature 4, the efficiency of ion ejection from the MSAE-type LIT largely depends on the gas pressure in the internal space of the LIT and the height of the barrier potential. According to the above simulation, it was found that increasing the barrier potential is advantageous in realizing a high mass resolution, but the ion ejection efficiency decreases. Such a phenomenon is an influence of an edge electric field generated by an aperture electrode or a grid electrode provided between the first LIT and the second LIT in the dual LIT.

The mechanism of the ion ejection operation in the MSAE-type LIT described in Patent Literature 4 is as follows.

In the vicinity of the edge electric field of the first LIT, various free movements of ions are coupled. The quadrupole mass separator using only the RF electric field operates on the principle that a part of the component of the energy in the radial direction is coupled to the motion in the axial direction of the ion in which the kinetic energy toward the exit direction is generated larger than expected. The kinetic energy of the ions largely displaced in the radial direction in the edge electric field of the outlet is increased more in proportion to the displacement due to the coupling between the radial direction and the axial direction as compared with the ions slightly displaced in the radial direction.

According to the disclosure of Patent Literature 4, when an excitation voltage is applied to the rod electrode of the LIT, only ions located in a region at a distance of 5.5 ro (ro is an inscribed circle radius of the rod electrode) in the axial direction from the end portion of the LIT can be ejected. As exemplified in the literature, when ro is 4 mm, the length of the region is 22 mm. In a device in which the length of the rod electrode of the first LIT is 30 ro, the ejection efficiency of ions from the first LIT is 18%. That is, the remaining 82% of the ions remain in the first LIT and are subsequently lost. In Patent Literature 4, the reason why such an axially long LIT is adopted is unknown, but according to the study of the present inventors, it is apparent that most of the length of the LIT is redundant in the device disclosed in Patent Literature 4 or the like.

In any case, in the above-described existing device, the charge capacity of the first LIT is small, that is, the amount of ions that can be accumulated in the internal space of the first LIT is considerably limited, and the efficiency in ejecting ions in the axial direction is also greatly restricted. The present inventors performed simulation on this device, and the ion transfer efficiency in a case where a sufficient time (7 msec) for ion cooling was given was 73% at the maximum.

The problem caused by the edge electric field as described above can be solved by replacing the aperture electrode or the grid electrode with the post-rod portion to which the barrier voltage is applied. By forming the potential barrier using the post-rod portion 302, the mass-selective transfer of ions from the first LIT 3 to the second LIT 4 can be executed substantially without loss.

The mechanism when ions are ejected from the first LIT 3 in the mass spectrometer of the present embodiment is as follows.

The ions trapped in the first LIT 3 are excited by a dipole AC excitation electric field (or a quadrupole excitation electric field) corresponding to a secular frequency of the ions. Ions having a corresponding secular frequency (the mass-to-charge ratio is directly proportional to the secular frequency) are excited in the first LIT 3 to obtain radial energy, which is not sufficient to eject the ions in the radial direction. Therefore, the excited ions diffuse forward and backward in the axial direction parallel to the axis 100 of the first LIT 3. When the ions are in the vicinity of the barrier potential by the post-rod portion 302, it is possible to obtain energy in the axial direction sufficient to get over the barrier potential by collision with the buffer gas molecules. This is because the radial velocity is partially converted into the axial velocity by the collision with the gas molecules.

When the axial velocity component obtained as described above is in the direction in which the barrier potential is located, the velocity may be sufficient for ions to climb over the barrier potential. Once the ions have climbed over the barrier potential, they may move to a region of sufficiently low potential that they cannot return to the first LIT 3. The second LIT 4 is disposed on the downstream side of the ion flow axially ejected from the first LIT 3, and ions easily and reliably enter the second LIT 4.

The first LIT 3 and the second LIT 4 may be driven such that the ions have substantially the same Mathieu parameter q. In such a case, ions are then trapped in a pseudopotential well in substantially the same radial direction. In addition, unlike the conventional dual LIT, there is no edge electric field that is a main factor causing ion loss when ions move from the first LIT 3 to the second LIT 4. Therefore, the conditions for trapping ions in the radial direction are substantially continuous from the first LIT 3 to the second LIT 4, and ions move substantially without loss from the first LIT 3 to the second LIT 4.

### <Improvement of Simultaneous Mass Scan Method in Dual LIT>

Another feature of the dual LIT in the mass spectrometer of the present embodiment is to address the problem of the simultaneous mass scan in the dual LIT.

As shown in Patent Literature 4, the mass offset between the first LIT 3 and the second LIT 4 when performing simultaneous mass scan in the dual LIT is not constant over the entire mass scan and increases rapidly as described above. When the mass scans in both LITs are both linear scans (means that the resonantly excited mass-to-charge ratio value is linearly proportional to the scan time (time elapsed from the start of the scan)), the mass offset increases as the mass scan progresses. Now, assuming that m_{offset_start} is a mass offset at the start of the mass scan, and mₛₜₐᵣₜ and m_{end} are mass-to-charge ratio values corresponding to the start and end of the mass scan, respectively, the mass offset m_{offset_end} at the end of the mass scan is given by the following Equation (1).

$${m}_{offset\_end} = ( {m}_{offset\_start} \times {m}_{end} ) / {m}_{start} \qquad ( 1 )$$

Equation (1) above means that the wider the mass-to-charge ratio range scanned, the larger the mass offset, leading to a decrease in the performance of the LIT. That is, the large mass offset means that the mass-to-charge ratio range of ions that must be trapped in the second LIT 4 is increased accordingly. This means that the charge capacity of the internal space of the second LIT 4 decreases, that is, the amount (ion amount) that can trap ions having a specific mass-to-charge ratio in the internal space of the second LIT 4 decreases on average.

For example, if the end mass-to-charge ratio of the mass-to-charge ratio range to be scanned is 10 times the start mass-to-charge ratio and the mass offset at the start of the scan is 5 Da, then the mass offset at the end of the scan is 50 Da. The average mass offset of the entire mass scan is then 25 Da. Thus, compared to when the mass offset is constant 5 Da throughout the mass scan, the charge capacity of the dual LIT decreases to about ⅕. As a result, the amount of ions to be subjected to mass spectrometry decreases, and the spectrometry sensitivity may be lowered.

To solve the above problem, it is necessary to perform one or both mass scans in the simultaneous mass scan in a non-linear manner in order to correct the mass offset expanding as the mass scan progresses. This may be achieved by adjusting the voltage control program in either or both of the power supply unit driving the first LIT 3 and the power supply unit driving the second LIT 4 to perform a simultaneous mass scan while keeping the mass offset constant.

In an RF voltage generator configured by a general analog circuit tuned in accordance with mass scan as disclosed in Non Patent Literature 1 or the like, the generator is out of a tuning state due to capacitive coupling between ion optical elements (LITs in this case). Therefore, such a voltage generator is not suitable for driving a plurality of ion optical elements disposed in close proximity. Such a deviation from the tuning state is particularly problematic when a wide mass-to-charge ratio range is scanned.

On the other hand, the present inventors have found that the above problem can be solved by using a rectangular wave-shaped RF voltage as disclosed in Patent Literature 7 as an RF voltage for trapping ions in the radial direction. The device disclosed in Patent Literature 7 uses an RF digital power supply including a direct digital synthesizer (DDS) controller, a field programmable gate array (FPGA), and a high-voltage high-speed switching MOSFET configured to switch between two voltage levels of high and low, and scans a frequency of a rectangular wave-shaped RF voltage to cause mass-selective resonant excitation and ejection of ions in an ion trap. By adopting this technology and applying RF voltages independently from the two RF digital power supplies to the first LIT 3 and the second LIT 4 in the dual LIT, it is possible to perform simultaneous mass scan over a wide mass-to-charge ratio range while keeping the mass offset constant.

As disclosed or suggested in Patent Literature 7, the sequence of mass scans as described above can be digitally programmed. The RF digital power supply can also provide a rectangular wave-shaped AC excitation voltage with frequency locked with high accuracy. Furthermore, the rectangular wave-shaped AC excitation voltage can be provided as a voltage having a fixed frequency ratio to the frequency of the rectangular wave-shaped RF voltage. In the device disclosed in Patent Literature 7, the AC excitation voltage has a cycle of an integral multiple of the cycle of the RF voltage, and a value of the multiple is 3 or more, usually 3 or 4.

In the frequency scan method as disclosed in Patent Literature 7, the cycle of the initial voltage waveform and the cycle of the final voltage waveform are determined. In the case of the forward scan, the cycle of the voltage waveform is increased by a constant step width ΔTₛₜₑₚ by a constant number of RF cycles N_{wave}. This achieves a linear mass scan at any scan speed.

For the purpose of performing the simultaneous mass scan in a dual LIT, a DDS controller and FPGA included in the RF digital power supply may be programmed to provide an optional and desired constant mass offset for the entire simultaneous mass scan over the mass-to-charge ratio range of interest, optionally at a desired scan speed. As a result, the throughput of ions in the dual LIT is greatly increased compared to the related art. The DDS controller and the FPGA may be programmed such that the mass offset gradually increases as the mass scan progresses in order to extend the cooling time as the mass-to-charge ratio of the ions to be processed increases during the mass scan. This can maximize ion throughput at any desired scan speed.

<Ion Ejection Method from First LIT>

Next, a characteristic ion resonant excitation method when ions are ejected from the first LIT 3 will be described.

Patent Literature 5 discloses a method for mass-selectively resonantly exciting and ejecting ions in an ion trap using a frequency scan method. In the method, both the RF voltage for ion trapping and the dipole AC excitation voltage are applied to the ion trap as a rectangular wave voltage. The cycle of the rectangular wave-shaped dipole AC excitation voltage is set to an integral multiple of the cycle of the rectangular wave-shaped RF voltage. On the other hand, the present inventors have found that the cycle of the AC excitation voltage for resonantly exciting the ion is not limited to an integral multiple of the cycle of the RF voltage for ion trapping. In the case of using the above-described DDS technology, the timing of a certain signal waveform can be generated using a rectangular-wave reference signal having a higher frequency. In the following description, the AC voltage waveform generated by the DDS technology is referred to as DDS voltage waveform. The frequency of the DDS voltage waveform can be N_{division} times the RF voltage waveform. Here, N_{division} is 2^{m} (m is an integer of 1 to 7). In a current common DDS technology, m is limited to 7 or less, and N_{division} is limited to 128 or less. Of course, with further development of future DDS technology, m may take higher values.

The present inventors have found that the cycle of the dipole AC excitation voltage can be set to an integral multiple of the cycle of the DDS voltage waveform when the cycle of the dipole AC excitation voltage is larger than 2N_{division}. As a result, a selection range of values that can be taken with respect to the ejection q value is widened as compared with the prior art. If the value of N_{division} is appropriately widened, the continuous ejection q value will correspond to a mass-to-charge ratio value at a narrower interval. Based on such findings, the present inventors have concluded that it is possible to achieve higher ion transfer efficiency by simultaneously applying a plurality of AC excitation voltages corresponding to a plurality of adjacent ejection q values to the LIT.

As described above, in the resonant excitation method in which the RF voltage and the AC excitation voltage are respectively applied to the rod electrodes of the LIT, a plurality of types of AC excitation voltages are generated in a programmable logic device (PLD) or the like, and mass scan is performed in a state where the ejection q value is fixed, so that a plurality of resonance lines different from each other can be generated in a stable region diagram based on a known Mathieu equation. The mass spectrometer of the present embodiment uses multiple dipole AC excitation based on such a principle in order to transfer ions from the first LIT 3 with high efficiency under a wider range of scanning conditions.

When the amplitude of the dipole AC excitation voltage is below a predetermined limit, the ejection of ions in the axial direction from the MSAE-type LIT may be performed under certain conditions without loss of ions. However, in such a case, the time for ejecting all the ions having a desired mass-to-charge ratio in the axial direction may be insufficient during the mass scan. Then, some ions remain trapped in the first LIT 3, and as the mass scan progresses, the ions remaining in the first LIT 3 disappear due to boundary ejection.

The operating conditions of the MSAE-type LIT are desirably determined such that the LIT can achieve an ion transfer efficiency of substantially 100% (or very close to 100%). However, such operating conditions are not necessarily beneficial in other respects. There are several operating parameters that affect the number of ions transferred from the first LIT 3 to the second LIT 4 in a mass scan using a single dipole AC excitation voltage. Specifically, the main operating parameters that affect the ion transfer efficiency include the scan speed of the mass scan, the buffer gas pressure, the axial length of the LIT, the inscribed circle radius of the rod electrode of the LIT, and the like.

When the transfer efficiency of ions is insufficient with a single dipole AC excitation voltage due to these factors, it is possible to improve the transfer efficiency of ions by utilizing multiple dipole AC excitation. The multiple dipole AC excitation described herein is to resonantly excite ions by simultaneously applying at least two types of AC dipole excitation voltages to the LIT.

Operation and behavior of ions at the time of multiple dipole AC excitation drive will be described. The multiple dipole AC excitation drive is implemented in two stages, a first operating mode and a second operating mode.

In the first operating mode, the interval of the plurality of dipole AC excitation voltages (this “interval” is the difference in the mass-to-charge ratio region corresponding to the difference in frequency of the excitation voltages) is set larger than the peak width on the mass spectrum due to the single dipole AC resonant excitation. That is, the plurality of dipole AC excitation voltages resonantly excite a plurality of ion species having mass-to-charge ratios that are clearly different (but very close) from each other. Therefore, ions having a certain mass-to-charge ratio are excited a plurality of times corresponding to each dipole AC excitation voltage (that is, become in a resonance state) as the mass scan progresses.

In the first operating mode, it is necessary to appropriately set the amplitude of the dipole AC excitation voltage so that the excited ions do not disappear in the radial direction (Y-axis direction) with respect to the rod electrode pair in the Y-axis direction (rod electrode pair to which the AC excitation voltage is applied). This may be different from the conditions that are optimal for a single dipole AC excitation. Importantly, the amplitude of the multiple dipole AC excitation voltage is such that it does not substantially result in ion loss in the radial direction in the MSAE-type LIT. It is apparent to those skilled in the art that the optimum value of the amplitude of the dipole AC excitation voltage in the LIT depends on parameters such as the buffer gas pressure, the inscribed circle radius of the rod electrode of the LIT, the shape of the rod electrode, and the scan speed. Therefore, a person skilled in the art can set the amplitude of the dipole AC excitation voltage to an appropriate value in consideration of the above factors experimentally or by simulation or the like.

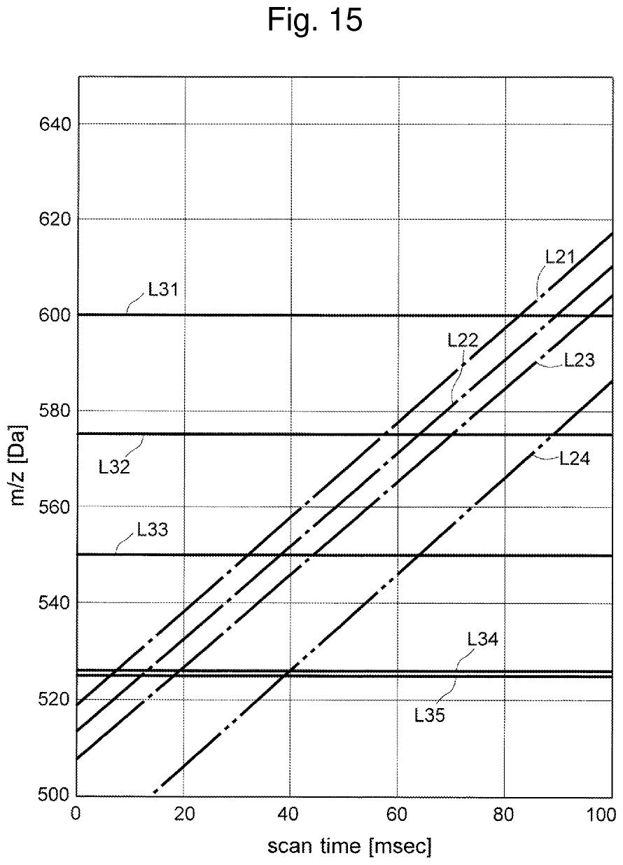

The mechanism of resonant excitation of ions by the above operation will be described in more detail with reference to FIG. 15. FIG. 15 is a scan line diagram illustrating the relationship between the elapsed time in a mass scan by multiple dipole AC excitation and the mass-to-charge ratio of excited ions. In FIG. 15, the horizontal axis represents the elapsed time from the start of scan, and the vertical axis represents the mass-to-charge ratio of ions.

FIG. 15 illustrates scan lines L21, L22, and L23 corresponding to each scan when the frequencies of three types of dipole AC excitation voltages are scanned. Each of these scan lines L21, L22, and L23 indicates the mass-to-charge ratio of ions that are excited, i.e., ejected from the LIT, at any time point during the scan. In the case of single-dipole AC excitation, there is only one scan line. On the other hand, in the multiple dipole AC excitation, as illustrated in FIG. 15, a plurality of (three in this example) scan lines L21, L22, and L23 are simultaneously present.

The plurality of scan lines L21, L22, and L23 intersect the mass-to-charge ratio lines L31, L32, L33, L34, and L35 extending horizontally, respectively. The mass-to-charge ratio lines L31, L32, L33, L34, and L35 correspond to m/z 600, 575, 550, 526, and 525, respectively. The point at which one mass-to-charge ratio line and one scan line intersect indicates the timing at which the ions move from the first LIT 3 to the second LIT 4 and the mass-to-charge ratio of the ions, for example, in the dual LIT illustrated in FIG. 2. Therefore, focusing now on, for example, the ion species at m/z 575 indicated by the mass-to-charge ratio line L32, the ion species are first ejected from the first LIT 3 at a time point of about 57 msec along the scan line L21, then again ejected from the first LIT 3 at a time point of about 64 msec along the scan line L22, and finally again ejected from the first LIT 3 at a time point of about 70 msec along the scan line L23 after the mass scan is started. That is, as described above, ion species having the same mass-to-charge ratio are excited in order (substantially continuously) corresponding to different single dipole AC excitation voltages, respectively, and are ejected from the first LIT 3 and moved to the second LIT 4.

Since the number of scan lines increases as the number of dipole AC excitation voltages applied simultaneously increases, the number of times the same ion species are excited increases accordingly. In this manner, the ions remaining in the first LIT 3 without being ejected by one dipole AC excitation are repeatedly excited by another dipole AC excitation a plurality of times, enabling the ions to be ejected from the first LIT 3 without waste (so as not to substantially remain in the first LIT 3). Note that, in FIG. 15, the scan line L24 has a predetermined mass-to-charge ratio width larger than those of the scan lines L21 to L23, which indicates ejection of ions from the second LIT 4.

In the first operating mode, n dipole AC excitation voltages are scanned simultaneously so as to generate n consecutive resonant excitations for ions with a given mass-to-charge ratio. As a result of the resonant excitation, most of the ions having the mass-to-charge ratio are ejected from the first LIT 3, but some of the ions still remain in the first LIT 3. In the first operating mode, the ratio C of the ejected (transferred) ions is expressed by the following Equation (2).

$$C ( \% ) = 1 - {( 1 - ρ )}^{n} \qquad ( 2 )$$

In the equation, n is the number of dipole AC excitation voltages applied simultaneously. In addition, ρ is the ion transfer efficiency with a single dipole AC excitation voltage. Therefore, for example, in the case of ρ=30%, the ratio of the ejected ions is 51%, 66%, 75%, 83%, 88%, 92%, 94%, 96%, and 97% with respect to each value of n=2 to 10.

In a second operating mode implemented following the first operating mode, the interval of the plurality of dipole AC excitation voltages (differences in the mass-to-charge ratio regions described above) is set to be less than the width of a single dipole AC resonant excitation. When such a multiple dipole AC excitation voltage is applied to the first LIT 3, the resonance of one specific ion species (that is, an ion species having a specific mass-to-charge ratio) is sustained for a longer time than when a single dipole AC excitation voltage is applied. As a result, the time during which a certain ion species is ejected in the axial direction becomes long, and the ejection efficiency is improved. However, in the second operating mode, the amplitude of the dipole AC excitation voltage needs to be smaller than that in the first operating mode. That is, in order to optimize mass scan using multiple dipole AC excitation, it is preferable that the amplitude and the relative phase of each dipole AC excitation voltage can be set independently of each other.

The mass scan using the multiple dipole AC excitation is particularly useful when the ejection efficiency of the ions in the axial direction by the mass scan using the single dipole AC excitation is less than 100%, but the transfer of the ions is performed without loss, that is, ions other than the ions transferred to the second LIT 4 remain in the first LIT 3. The reduction in axial ion ejection efficiency due to mass scan using single dipole AC excitation often occurs particularly when the scan speed is increased. Therefore, the mass scan using the multiple dipole AC excitation is particularly effective for increasing the ion transfer efficiency in the MSAE-type LIT in the mass spectrometer of the present embodiment.

Note that the mass scan using the multiple dipole AC excitation is applicable not only to the MSAE-type LIT but also to the MSRE-type LIT (that is, the second LIT 4). In the case of the MSRE-type LIT, by using multiple dipole AC excitation scans, in which the frequencies of a plurality of dipole AC excitation voltages are very close (that is, interval between the scan lines in FIG. 15 is narrow), it is possible to optimize the ejection operation of ions in the radial direction from the LIT. As a result, it is possible to improve the ion ejection efficiency and the mass resolution of the ions.

### <Drive Method of Second LIT>

An example of a method for driving the second LIT 4 to trap ions in the second LIT 4 and to eject ions from the second LIT 4 will be described.

As illustrated in FIG. 5, among the four rod electrodes 4021 to 4024 constituting the second LIT 4, an AC power supply 111 is connected to a pair of rod electrodes 4022 and 4024 facing each other in the X-axis direction across the axis 100 via a switch 112. One output terminal 1104 of the RF power supply 110 is connected to a pair of rod electrodes 4021 and 4023 facing each other in the Y-axis direction across the axis 100 among the four rod electrodes 4021 to 4024. The switch 112 switches between the output voltage from the AC power supply 111 and the voltage RF2 output from the other output terminal 1105 of the RF power supply 110. The RF power supply 110 includes a switch 1103 that switches between the voltage value V and 0 V (ground potential), a switch 1101 that switches between the voltage value 2 V and the voltage value V, and a switch 1102 that switches between the output of the switch 1101 and 0 V (ground potential).

The AC power supply 111 generates a rectangular wave-shaped AC excitation voltage to resonantly excite ions having a particular mass-to-charge ratio that are trapped in the internal space 405 of the second LIT 4. On the other hand, the RF power supply 110 generates a rectangular wave-shaped RF voltage (RF1, RF2) for confining ions in the internal space 405 of the second LIT 4.

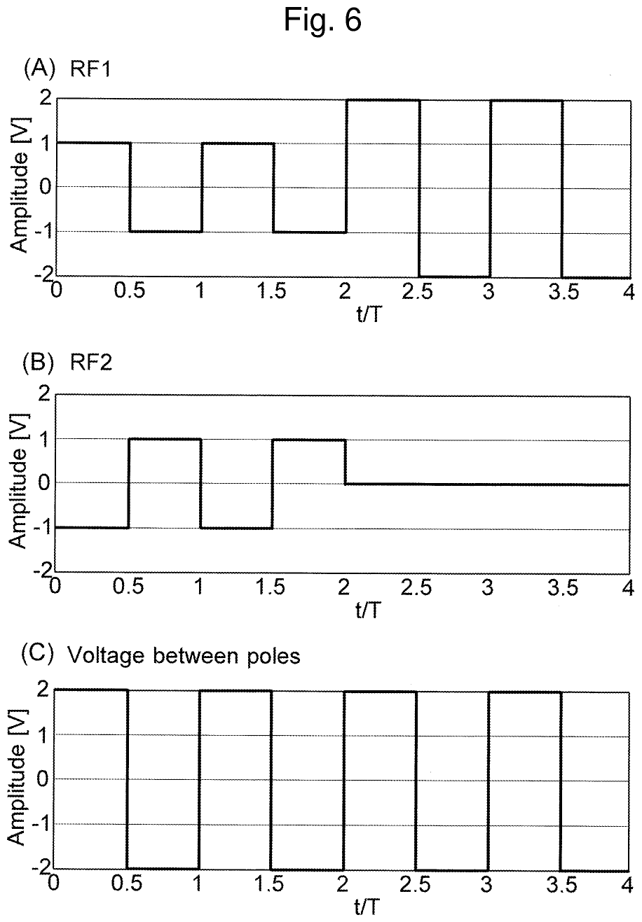

FIG. 6(A)-(B) includes two typical output voltage waveforms of the RF power supply 110. The amplitude of each voltage waveform is normalized by V. In the diagrams, Vis the RF amplitude value used in well-known equations for the Mathieu parameter q and T is the cycle of the RF voltage. The output voltage waveforms RF1 and RF2 effectively switch the second LIT 4 between two-phase RF drive and single-phase RF drive. FIG. 6C illustrates an effective voltage waveform between the two rod electrodes 4021 and 4023.

When ions are transferred from the first LIT 3 to the second LIT 4, both the switches 112 and 1101 are switched to select the lower side in FIG. 5. The switches 1102, 1103 each alternate at a predetermined timing to produce a rectangular wave-shaped RF voltage. As illustrated in the period of t/T=0 to 2 in FIG. 6(A)-6(B), at this time, RF1 and RF2 are rectangular wave-shaped RF voltages having opposite phases at the same frequency. Therefore, RF voltages (RF1, RF2) having peak values of V and phases opposite to each other are applied to the two pairs of rod electrodes facing each other with the axis 100 interposed between them. That is, at this time, the second LIT 4 is driven by the two-phase RF. As a result, an RF quadrupole field is formed in the internal space 405 of the second LIT 4, and the potential on the axis 100 of the second LIT 4 is constant with respect to an external reference potential (for example, ground potential). Therefore, after the ions sent from the first LIT 3 are introduced into the second LIT 4, the ions are well trapped by the RF quadrupole field.

When ions are ejected from the second LIT 4 in the radial direction, both the switches 112 and 1101 are switched to select the upper side in FIG. 5. The switch 1102 alternates at a predetermined timing to produce a rectangular wave-shaped RF voltage. As illustrated in the period of t/T=2 to 4 in FIG. 6(A)-(B), at this time, RF1 is a rectangular wave-shaped RF voltage having a peak value of 2 V. Therefore, an RF voltage (RF1) having a peak value of 2 V is applied to the rod electrodes 4021 and 4023, and an AC excitation voltage having a predetermined peak value is applied to the rod electrodes 4022 and 4024. As a result, an RF quadrupole field is formed in the internal space 405 of the second LIT 4. At this time, the potential on the axis 100 of the second LIT 4 is constant with respect to the external reference potential. In addition, the potential on the axis 100 has an RF component that is half the peak value of 2 V of the applied RF voltage. Therefore, the formed quadrupole field is an electric field indistinguishable from a case where RF voltages (RF1, RF2) of two phases are applied with respect to the potential along the axis 100 for ions. In addition, the power consumption is substantially the same in both the single-phase RF drive and the two-phase RF drive.

In other words, once the ions enter the inside of the second LIT 4, there is no difference in the drive form for the ions, and the ions exhibit similar behavior in both the drive forms of the single-phase RF voltage (RF1 only) and the two-phase RF voltages (RF1, RF2) except for the ions to be resonantly excited. As a result, ions other than the resonantly excited ions continue to be stably trapped in the internal space 405 of the second LIT 4. As illustrated in FIG. 6(C), since the voltage waveform between the rod electrodes is continuous even at the time of transition between the two states described above, ions are stably trapped even at the time of transition.

On the other hand, ions having a specific mass-to-charge ratio corresponding to the frequency of the AC excitation voltage applied to the rod electrodes 4022 and 4024 are resonantly excited in the radial direction and greatly vibrate. Then, the ions are ejected through the ion ejection hole 404 of the second LIT 4. If the RF voltage for ion trapping is applied to the rod electrodes 4022 and 4024 at this time, the ions exiting from the ion ejection hole 404 pass through the RF electric field formed by the RF voltage for ion trapping, and the behavior of the ions is affected by the RF electric field. On the other hand, since the second LIT 4 is driven by the single-phase RF at the time of ion ejection, there is almost no undesired electric field outside the ion ejection hole 404, and therefore there is substantially no pseudopotential. As a result, the ions exiting from the ion ejection hole 404 can enter the ion focusing guide 8 without being affected by an electric field or a pseudopotential.

As described above, the RF power supply 110 which drives the second LIT 4 can selectively output the two-phase RF voltage and the single-phase RF voltage. Since the switching of each switch 112, 1101, 1102, 1103 is digitally controlled, the two-phase RF drive and the single-phase RF drive are quickly switched. Also at the time of switching, the ions trapped in the internal space 405 of the second LIT 4 continue to be stably trapped, and no loss of ions occurs.

As illustrated in FIG. 5, a shield electrode 406 is provided outside the ion ejection rod electrode 4024. When a single-phase RF voltage is applied to the rod electrodes 4021 and 4023, the shield electrode 406 shields an electric field formed outside the rod electrodes 4021 and 4023 to prevent the electric field from reaching the ion ejection region. As a result, in this device, the influence of the undesired RF electric field on the ions ejected from the second LIT 4 can be more reliably reduced.

The first LIT 3 and the second LIT 4 are preferably digitally driven as described above. However, the first LIT 3 and the second LIT 4 may be driven by a sinusoidal wave-shaped RF voltage as long as the mass-to-charge ratio range of the mass scan is not wide and adjustment of the ion optical system located downstream is not required.

### <Configuration and Operation of Ion Focusing Guide>

As described above, the ion group is ejected from the second LIT 4 with a large cross-sectional area, more specifically, with a cross-sectional area extending long in the direction of the axis 100. On the other hand, the area of the ion entrance of the bunching ion guide 5 is considerably smaller than the cross-sectional area of the ion group. In addition, the energy of the ions ejected from the second LIT 4 depends on the method of the mass scan operation in the second LIT 4, and when the amplitude of the RF voltage for trapping is set to be larger so as to obtain a higher q value, the energy of the ions at the time of ejection increases. The ion focusing guide 8 is disposed between the second LIT 4 and the bunching ion guide 5, gathers ions ejected from the second LIT 4 as thoroughly as possible, and delivers the ions as the ion group having a small cross-sectional area to the bunching ion guide 5.

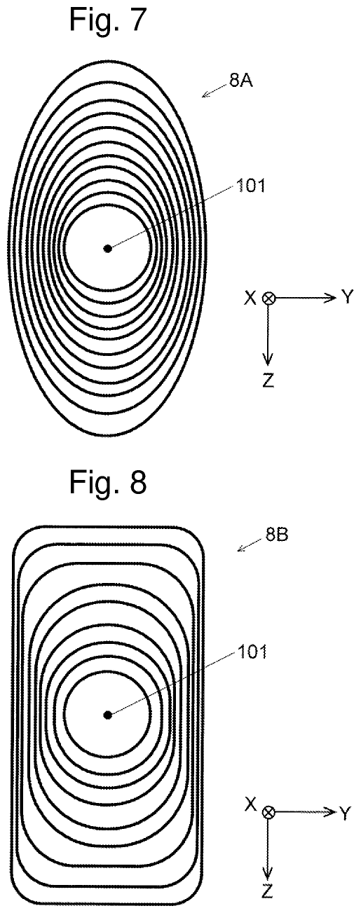

In the mass spectrometer of the present embodiment, the ion focusing guide 8 includes a plurality of guide electrodes 801 arrayed along its axis 101 and each extending in a plane orthogonal to the axis 101. A tapered ion passage path 802 is formed inside the opening portions of the plurality of guide electrodes 801. In the example illustrated in FIGS. 2 and 3, an inlet-end guide electrode 801A disposed at the inlet end of the ion passage path 802 has an elliptical annular shape having a substantially elliptical opening having a major axis in the Z-axis direction and a minor axis in the Y-axis direction as illustrated in FIG. 7, and an outlet-end guide electrode 801B disposed at the outlet end of the ion passage path 802 has an annular shape having a substantially circular opening. Between the inlet-end guide electrode 801A and the outlet-end guide electrode 801B, a large number of substantially elliptical annular guide electrodes 801 in which the area of the opening gradually decreases substantially continuously (so that the degree of decrease in major axis is larger than the degree of decrease in minor axis) are arranged along the axis 101. That is, the ion focusing guide 8 has an ion funnel structure in which the cross-sectional area of the inlet opening is larger than the cross-sectional area of the outlet opening.

As illustrated in FIG. 3, in the second LIT 4, the ion ejection rod electrode 4024 has a recess 4024A whose outer surface is largely recessed inward (in the direction of the central axis of the second LIT 4). The guide electrode 801 included in a range 801C having a predetermined length in the axial direction on the ion inlet side of the ion focusing guide 8 is configured to enter the inside of the recess 4024A. As a result, the ion inlet of the ion focusing guide 8 can be positioned in the immediate vicinity of the ion ejection hole 404 while the ion ejection rod electrode 4024 itself has a sufficient thickness in the direction of the axis 101. Since the ions discharged from the internal space (ion trap space) 405 of the second LIT 4 through the ion ejection hole 404 advance in various directions, the ions spread after exiting from the ion ejection hole 404. On the other hand, in the configuration of this embodiment, since the ion inlet of the ion focusing guide 8 is located in the immediate vicinity of the exit of the ion ejection hole 404, ions that exit from the ion ejection hole 404 and travel in various directions can be efficiently taken into the ion passage path 802, and the loss of ions can be suppressed.

Although not illustrated, a predetermined RF voltage is applied to each of the plurality of guide electrodes 801. As a result, the plurality of guide electrodes 801 form an RF electric field in the ion passage path 802 that confines the received ion group in the radial direction as described above. The RF voltage applied to each of the plurality of guide electrodes 801 arranged in the direction of the axis 101 at this time is such an RF voltage that there is a certain degree of phase fluctuation along the axis 101. Usually, RF voltages having phases opposite to each other are applied to the two guide electrodes 801 adjacent in the direction of the axis 101.

In addition to the RF voltage, a predetermined DC voltage is applied to each of the plurality of guide electrodes 801. This forms a DC electric field indicating a predetermined potential distribution in the axis 101 direction in at least a partial range along the axis 101 in the ion passage path 802. This DC electric field is an electric field that gives energy to ions so as to promote the movement of the ions in the ion passage path 802 from the ion inlet end toward the ion outlet end. The DC voltage can have a configuration in which a predetermined DC voltage is applied to both ends of the ladder resistance circuit, for example, and voltages divided from the resistors of the respective stages of the ladder resistance circuit are extracted and applied to the respective guide electrodes 801. However, the DC potential distribution in the direction of the axis 101 may not be uniform along the axis 101 of the ion passage path 802, and the potential gradient in the direction of the axis 101 may not be linear.

Furthermore, the ion focusing guide 8 may include a gas supply unit which supplies a buffer gas to the ion passage path 802. A part or all of the buffer gas may be directly introduced into the ion passage path 802, but as illustrated in FIG. 13, the buffer gas may be introduced into the ion passage path 802 through the bunching ion guide 5 on the downstream side. The ion focusing guide 8 can also include exhaust means, preferably a turbo-molecular pump. The buffer gas is made of at least one gas species. In the ion focusing guide 8, the gas pressure has a gradient along at least a part or all of the direction of the axis 101 of the ion passage path 802. In the gradient of the gas pressure, the pressure of the buffer gas at the inlet end of the ion passage path 802 is lower than the pressure of the buffer gas at the outlet end.

The ion focusing guide 8 communicates with the internal space 405 of the second LIT 4 only through the ion ejection hole 404, that is, is configured such that fluids such as gas pass through each other. This means that the ion ejection hole 404 is the only opening portion for gas particles to move between the two chambers 20, 21. The ion outlet end of the ion passage path 802 is also the only opening through which a fluid can flow between the ion outlet end and the bunching ion guide 5 on the downstream side. Optionally, the ion passage path 802 may be an open structure through which gas in the passage path 802 can enter and exit through a side face or a peripheral face of the passage path. In addition, the ion passage path 802 may have a closed portion closed so that gas does not flow through the side face or the peripheral face of the passage path.

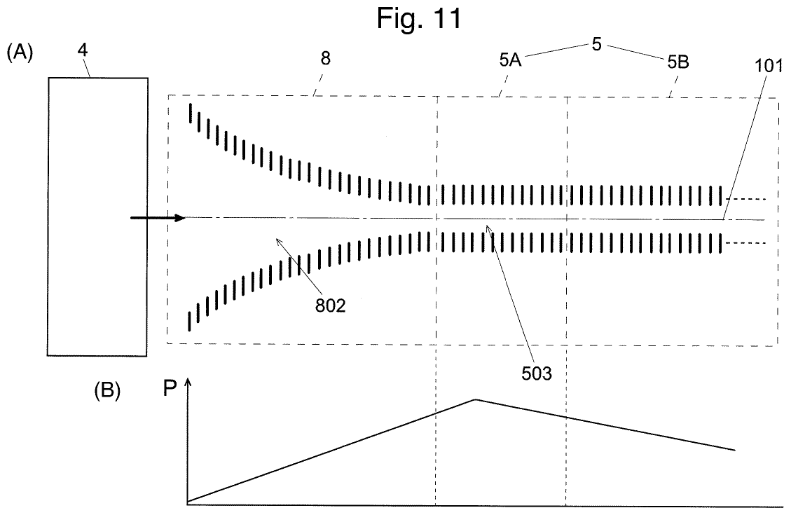

An example of the distribution of the gas pressure in the direction parallel to the axis 101 over the ion focusing guide 8 and the entire bunching ion guide 5 located downstream is illustrated in FIG. 11.

FIG. 11(A) illustrates the second LIT 4, the ion focusing guide 8, and the bunching ion guide 5, and the bunching ion guide 5 includes a bunch forming portion 5A and an ion bunch transporting portion 5B. FIG. 11(B) illustrates a profile P of a preferred gas pressure. The gas pressure in the chamber 20 in which the second LIT 4 is disposed is typically in the range of 1×10⁻² Pa to 2×10⁻¹ Pa. A typical gas pressure in the ion passage path 802 of the ion focusing guide 8 is in a range of 1×10⁻¹ to 5 Pa. In addition, a typical pressure in the bunch forming portion 5A of the bunching ion guide 5 is in the range of 1 to 50 Pa.

The gas pressure gradually increases towards the traveling direction of ions along the axis 101 of the ion focusing guide 8 and reaches a maximum, typically 5 Pa, in the bunch forming portion 5A of the bunching ion guide 5. Then, downstream of the bunch forming portion 5A, the gas pressure gradually decreases along the axis 101. Note that a parameter for forming an electric field that confines ions in the radial direction in the ion focusing guide 8 and the bunching ion guide 5 depends on the mass-to-charge ratio of the target ions, but typically, the frequency of the RF voltage is in a range of several hundred kHz to several MHz, and the amplitude of the RF voltage is in a range of several tens V to several hundreds V.

Under a typical scan speed of 1000 Th/s, an ion group including a plurality of ions divided for each mass-to-charge ratio range of 1 Th is sequentially ejected from the second LIT 4 at intervals of 1 msec in terms of time. The duration of one ion ejection is the time required for one ion group to be ejected from the second LIT 4, and is typically 0.3 msec. Each ion group is ejected with a wide range of axial energies between 0 eV and 1600 eV.

Therefore, when the ejected ion group enters the ion focusing guide 8, the ions included in the ion group have the axial energy spread as described above. The ion focusing guide 8 receives ions having such an energy spread and cools high-energy ions in one ion group. On the other hand, the energy is increased by the potential gradient formed in the ion passage path 802 so that the low-energy ions are not delayed from the high-energy ions. As a result, at the stage of reaching the outlet end of the ion focusing guide 8, all ions are transported with an energy distribution converged to a narrow width.

The time required for the ions to pass through the ion focusing guide 8 is about 120 usec or less. The variation in the passage time of ions having a wide mass-to-charge ratio range is 70 usec or less. The variation in the passage time of ions of a single mass-to-charge ratio is 25 usec or less. Due to the important properties of the ion focusing guide 8, the mass resolution in the second LIT 4 which ejects ions is substantially maintained both at the outlet end of the ion focusing guide 8 and also when those ions enter the bunching ion guide 5.

The ion focusing guide 8 not only converges the variation in the passage direction of the ions included in the ion group (variation in the transport time), but also effectively converges the spread of the ions in the lateral direction (radial direction) of the ion group ejected from the second LIT 4. Referring to FIG. 2, an ion cloud C1 extending in the direction of the axis 100 in a state of being trapped in the main rod portion 402 of the second LIT 4 contains ions of a wide mass-to-charge ratio range. As the mass scan in the second LIT 4 progresses, ion groups including ions in a narrow mass-to-charge ratio range are ejected one after another as ion groups spreading in the direction of the axis 100. Each of the ion groups includes ions in a narrow mass-to-charge ratio range (for example, 1 Da range).

The ion passage path 802 of the ion focusing guide 8 is configured to efficiently receive the ion group spreading in the direction of the axis 100, and as the ion group travels toward the outlet end along the direction of the axis 101 of the ion passage path 802, the size of the ion group spreading in the direction of the axis 100 gradually decreases in the spreading direction. That is, the ion group is focused so as to approach the axis 101 of the ion passage path 802. The spatial change of the ion group is schematically illustrated in FIG. 2. In FIG. 2, each ion group drawn in the process of passing through the ion passage path 802 is an ion group ejected from the second LIT 4 at different time points.

In addition, since the buffer gas is supplied to the ion passage path 802 of the ion focusing guide 8, ions having large energy and entering the ion passage path 802 collide with the buffer gas and are dissociated by the CID to generate product ions. In particular, since the width of the energy of the ions ejected from the second LIT 4 is large, CID is performed by both the high energy activation and the low energy activation in the ion passage path 802 of the ion focusing guide 8. The mode of dissociation by CID depends on the energy of the ion, and when the energy is different, different types of product ions are generated even if the ion species is the same. For this reason, when ions are dissociated in the region near the inlet of the ion focusing guide 8, the ions have large energy and the width of the energy is large, so that the ions are effectively dissociated and product ions in a wide mass-to-charge ratio range can be generated. Conventionally, in order to generate such various productions, it is necessary to perform control such as scanning a voltage that gives collision energy. On the other hand, in the mass spectrometer of the present embodiment, various productions derived from one ion species can be obtained without performing such special control.

The product ions generated and the ions not dissociated (precursor ions) are further brought into contact with the buffer gas and subjected to cooling. In this way, the ions included in the ion group ejected from the second LIT 4 and the product ions generated from the ions are sent to the bunching ion guide 5 in a state of being cooled to some extent or sufficiently while maintaining a substantially assembled state. By reliably receiving the ions ejected from the second LIT 4 at the inlet of the ion focusing guide 8 and transporting the ions while confining the ions in the radial direction, it is possible to minimize the loss of ions during the transport.

Of course, if necessary, an electrode may be appropriately disposed between the second LIT 4 and the ion focusing guide 8, and collision energy may be applied to the ions using a difference between a DC voltage applied to the electrode and a DC voltage applied to the second LIT 4 and the ion focusing guide 8.

In order to focus the ions well in the ion focusing guide 8, ions having high energy require cooling by multiple collisions with gas. In order to perform CID well, a certain degree of gas pressure is also required. On the other hand, when the gas pressure is too high, the temporal spread of the transport time of the ion groups passing through increases. This also causes variations in transport time between different ion groups. This variation in the transport time can be an obstacle for preventing the mixture of ions in the bunch forming portion 5A of the bunching ion guide 5. Therefore, it is desirable to appropriately set the gas pressure during operation so as not to cause a large difference in the transport time of a plurality of product ions derived from one type of precursor ion.

It is also important to appropriately adjust the DC potential gradient in the axial direction in order to reduce variations in the transport time of the ion group. That is, for optimal operation, it is necessary to shorten the transport time of ions as much as possible while enabling ions to collide with gas particles. In addition, it is necessary to set the DC potential gradient in the axial direction so as not to excessively accelerate ions. With such an appropriate condition setting, the ion group is well focused in the ion focusing guide 8 and can be well gathered in the next bunch forming portion 5A.

In addition, it is desirable that a difference (pressure ratio) in gas pressure between the region where the second LIT 4 is disposed and the ion inlet region in the ion focusing guide 8 is small. By keeping this pressure difference small, the conductance (easiness of passing) of the gas between the region of the second LIT 4 and the ion focusing guide 8 can be increased. As a result, it is possible to smoothen the flow of ions from the second LIT 4 to the ion focusing guide 8 to shorten the transport time of the ion group in the ion focusing guide 8.

To summarize the above description, the ion focusing guide 8 has the following structural and functional features.
The ion focusing guide 8 receives the group of ions ejected all at once from the second LIT 4 long in the direction of the axis 100 without loss as much as possible.
By the RF electric field formed by the voltage applied to the large number of guide electrodes 801 constituting the ion focusing guide 8, the received ion group is confined in the radial direction of the RF electric field.
By the voltage applied to the large number of guide electrodes 801 constituting the ion focusing guide 8, a DC electric field having a downward gradient is formed in the traveling direction of the ions in at least a partial region in the axis 101 direction. This electric field can accelerate the ions in their traveling direction in that region.
At least one type of buffer gas is introduced into the ion passage path 802 of the ion focusing guide 8. In addition, the buffer gas pressure at the inlet end of the ion passage path 802 is configured to be lower than the buffer gas pressure at the outlet end of the ion passage path 802.
As illustrated in FIG. 2, the ion passage path 802 of the ion focusing guide 8 communicates with the internal space 405 of the second LIT 4 only through the ion ejection hole 404 of the second LIT 4. That is, it is configured such that a fluid (gas) can pass from the second LIT 4 to the ion passage path 802 of the ion focusing guide 8. As a result, gas exchange between the chamber 20 in which the second LIT 4 is disposed and the chamber 21 in which the ion focusing guide 8 is disposed is performed only through the ion ejection hole 404.
As illustrated in FIG. 2, the outlet end of the ion focusing guide 8 is configured such that the fluid passes only to the bunching ion guide 5 on the downstream side of the outlet end. As a result, gas exchange between the chamber 21 in which the ion focusing guide 8 is disposed and the chamber 22 in which the bunching ion guide 5 is disposed is performed only through the outlet end of the ion focusing guide 8.

The ion focusing guide 8 may further have the following configuration.
A gate electrode for shielding ions may be provided at the outlet end of the ion passage path 802.
The average buffer gas pressure in the ion passage path 802 may be adjustable.
The gas pressure may be configured to have a gradient along the axis 101 in at least a partial region along the axis 101 of the ion passage path 802.

In addition, in the mass spectrometer of the present embodiment, the pressure of the buffer gas can be temporally adjusted or pulse-adjusted by using, for example, a pulse gas valve as the gas supply unit. This is effective to assist operation of 2DMS1×MS2 scans, which may be performed alternatingly with MS1 scans. This gas pressure adjustment function can also be used when switching between a case where ion dissociation is performed and a case where ion dissociation is not performed. That is, at the time of MS2 scan, a larger amount of buffer gas is supplied to the ion focusing guide 8 to promote the dissociation of ions, and at the time of MS1 scan, the amount of buffer gas supplied to the ion focusing guide 8 is reduced to make the dissociation of ions less likely to occur.

In addition, usually, when it is desired to acquire the MS1 spectrum using the TOF mass spectrometry unit capable of achieving higher mass resolution and mass accuracy than the mass scan in the second LIT 4, it is necessary to transport ions without causing dissociation in the ion focusing guide 8. This mass spectrometer can be used, for example, for MS1 spectrometry in the DIA, but the operation in that case is apparent to those skilled in the art.

### <Modification of Ion Focusing Guide>

The structure of the guide electrode 801 is not limited to the above-described example. Other forms of the shape and structure of the guide electrode 801 are illustrated in FIGS. 8, 9, and 10.

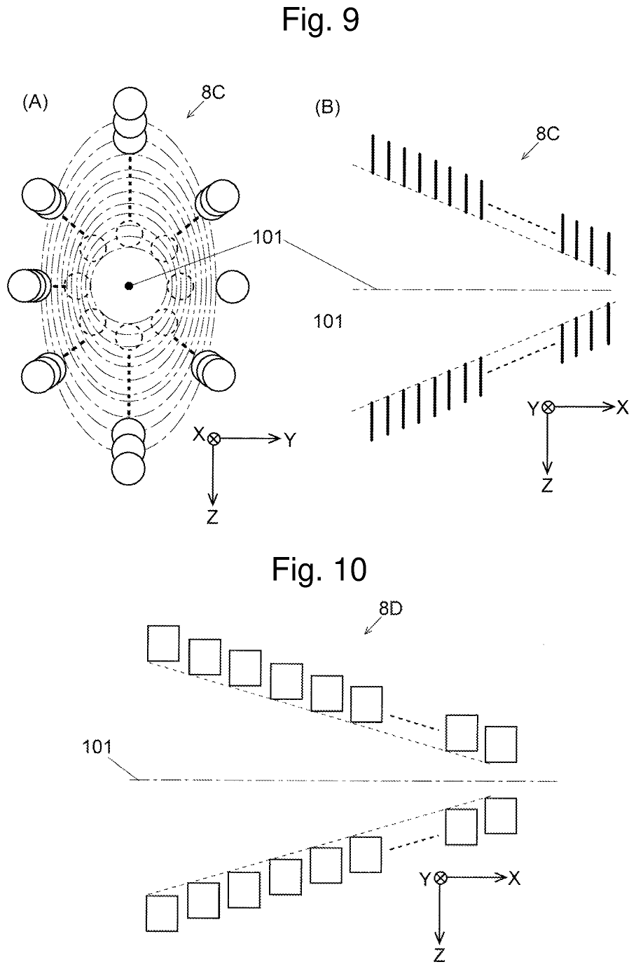

In the example of FIG. 8, the shape of the guide electrode 8A is not a substantially elliptical annular shape but a substantially rectangular shape with rounded corners. In the examples of FIGS. 9 and 10, guide electrodes 8C and 8D have a multipole (octpole in this example) structure including a plurality of electrodes surrounding the axis 101. In the example of FIG. 9, one electrode extending in the direction of the axis 101 has a large number of thin plates. In the example of FIG. 10, one electrode extending in the direction of the axis 101 includes a plurality of segment electrodes having a thickness in the direction of the axis 101. In the case of the examples of FIGS. 9 and 10, the RF electric field that confines the ions in the radial direction is formed by the RF voltages applied to the plurality of electrodes on the same cross section (plane orthogonal to the axis 101) such that the phases of the RF voltages at adjacent electrodes around the axis 101 are opposite one another.

In any form, the size in the Z-axis direction or the inscribed circle radius of the ion inlet end of the ion passage path 802 is larger than that of the ion outlet end. This is effective for reducing the size in the Z-axis direction of the ion group ejected from the second LIT 4 and enter the ion passage path 802 of the ion focusing guide 8 with the travel of the ion. Preferably, the size of the ion ejection hole 404 in the axis 100 direction in the second LIT 4 and the size of the ion inlet end of the ion passage path 802 in the Z axis direction may be the same. However, the shape and structure of the guide electrode 801 are not limited to the above.

In addition, a gate electrode may be provided at the outlet end of the ion passage path 802. When the gate electrode is present, a voltage pulse synchronized with the mass scan of the second LIT 4 may be applied to the gate electrode. By applying the voltage pulse, for example, ions that cannot pass through the gate electrode in a predetermined time width are shielded. As a result, for example, it is possible to exclude particularly preceding ions and lagging ions among ions that have spread in the direction parallel to the axis 101 due to variations in the effect of ion cooling or the like, and to avoid leakage of a part of ions that should originally form one ion bunch into another ion bunch in the bunching ion guide 5.

In addition, the various parameters in the second LIT 4 and the ion focusing guide 8 may be set to effectively dissociate ions by CID. The dissociation by the CID is not limited to the inlet region in the ion passage path 802 of the ion focusing guide 8, and may be performed in any region.

In addition, it is possible to dissociate precursor ions in a wide mass-to-charge ratio range without the user having prior knowledge and without adjusting some parameters. With such features, in the mass spectrometer according to the present invention, it is possible to further improve the duty cycle (ion usage) and the ion throughput. This is important in analyzing unknown samples, and can be used for various uses and applications.

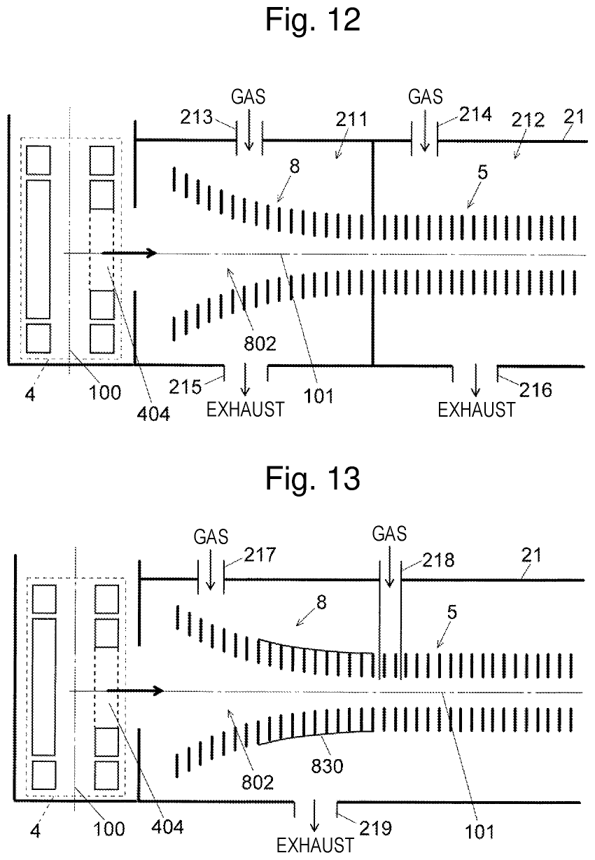

FIGS. 12 and 13 illustrate schematic diagrams of another example of the arrangement of the ion focusing guide 8 and the bunching ion guide 5. In the example of FIG. 12, the ion focusing guide 8 and the bunching ion guide 5 are accommodated in different chambers 21 and 22, respectively. A buffer gas such as He or Ar is supplied to the chamber 21 through a gas tube 213, and is evacuated from the chamber 21 through an exhaust tube 215. On the other hand, a buffer gas is supplied to the chamber 22 through a gas tube 214, and is evacuated from the chamber 22 through an exhaust tube 216. Therefore, the gas pressure of the ion focusing guide 8 and the gas pressure of the bunching ion guide 5 can be adjusted substantially independently.

In the example of FIG. 13, the ion focusing guide 8 and the bunching ion guide 5 are accommodated in the same chamber 21. A buffer gas is supplied to the chamber 21 through a gas tube 217, and is evacuated from the chamber 21 through an exhaust tube 219. Apart from this, the buffer gas is directly supplied to the internal region of the bunching ion guide 5 through a gas tube 218. Furthermore, a shielding portion 830 is provided on a peripheral face of a part of the outside of the guide electrode of the ion focusing guide 8 so that the gas does not escape from the ion passage path 802 to the outside. When the circulation of the gas is blocked or restricted by the shielding portion 830, the distribution of the gas pressure in the ion passage path 802 is affected. In this case, the gas pressure is maximum in the vicinity of the gas outlet of the gas tube 218, and the gas pressure decreases as the distance from the position increases in both the left and right directions. However, since the gas hardly escapes to the surroundings in the range surrounded by the shielding portion 830, the gas pressure clearly becomes higher than in the other range. As a result, the gas pressure can be increased to easily cause CID and cooling.

In addition, as described above, since the ions have large energy in the region near the inlet of the ion focusing guide 8, if the ions are dissociated in this region, the energy of the ions may be too large and the ions may be too fine. Therefore, in such a case, it is preferable to sufficiently increase the gas pressure on the downstream side of the ion focusing guide 8 (the portion close to the connection region with the bunching ion guide 5) and to efficiently dissociate the ions at that place. However, if it is attempted to increase the gas pressure on the downstream side of the ion passage path 802, the gas flows into the second LIT 4 side, and there is a concern that the gas pressure in the internal space of the second LIT 4 increases. This reduces the mass separability at the time of separating precursor ion or the like on the second LIT 4 side. According to the simulation, there is a difference of 100 times or more between the gas pressure appropriate for CID on the downstream side of the ion passage path 802 and the gas pressure appropriate for ion separation in the second LIT 4. Usually, in order to secure such a differential pressure, it is necessary to decrease the area of the ion ejection hole 404 or significantly increase the evacuation performance on the LIT side. The former leads to a decrease in ion extraction efficiency, and the latter leads to an increase in device cost.

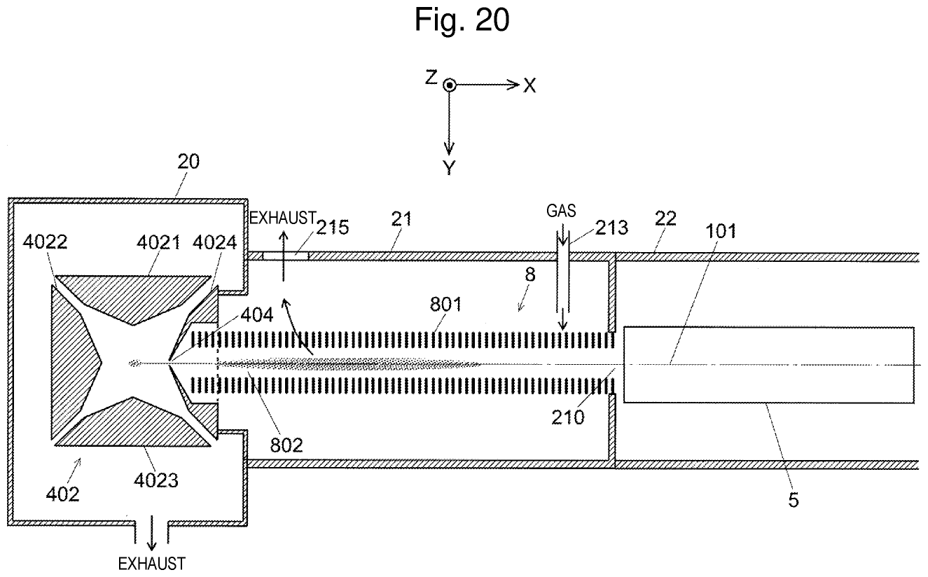

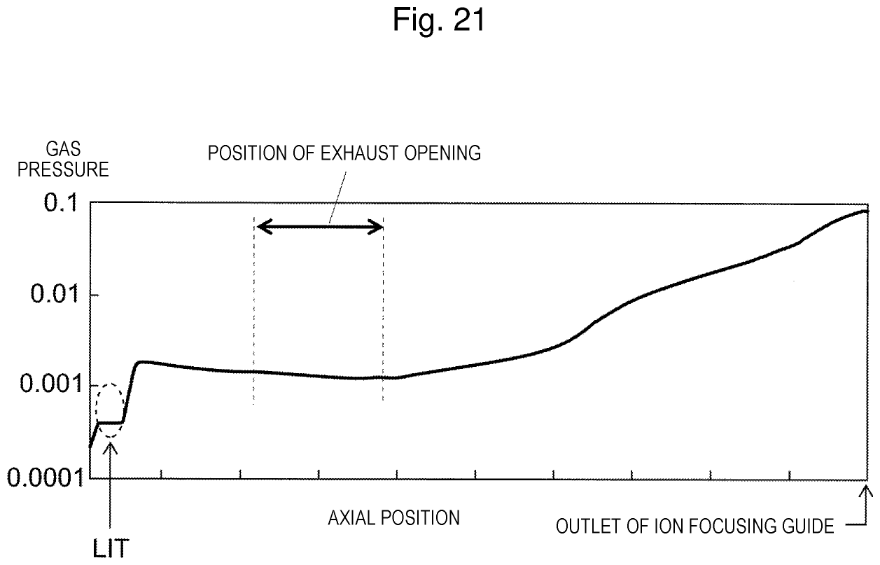

As one configuration for solving this, as illustrated in FIG. 20, in the chamber 21 in which the ion focusing guide 8 is disposed, a gas tube 213 for introducing a collision gas or a buffer gas may be provided on the downstream side of the ion passage path 802, and an opening 220 for degassing may be provided on the upstream side of the ion passage path 802. FIG. 21 illustrates an example of a simulation result of the gas pressure distribution along the axis 101 of the ion passage path 802 in such a configuration. As illustrated in FIG. 21, by providing the opening 220 for degassing, it is possible to sufficiently secure the differential pressure between the outlet and the inlet of the ion focusing guide 8. As a result, even if the area of the ion ejection hole 404 of the second LIT 4 is relatively increased, the differential pressure between the downstream side of the ion passage path 802 and the internal space 405 of the second LIT 4 can be increased. As a result, it is possible to achieve both high ion separability in the second LIT 4 and high ion dissociation efficiency in the ion focusing guide 8.

In the ion focusing guide 8 having an ion funnel structure as illustrated in FIGS. 2, 12, 13, and 20, the length, width, and opening angle in the direction of the axis 101 greatly affect the gas pressure distribution along the axis 101 in the ion passage path 802. For example, according to Non Patent Literature 2 and others, a gas conductance C in a gas flow convergence device such as a circular tapered tube with respect to a lean gas flow is calculated by the following Equation (3).

$$C = A \{ ( {D}_{1}^{2} \times {D}_{2}^{2} ) / ( {D}_{1} \times {D}_{2} ) L \} \qquad ( 3 )$$

In the equation, A is a constant according to the type and temperature of the gas, D₁ and D₂ are diameters of openings of the inlet-end guide electrode 801A and the outlet-end guide electrode 801B, and L is a length of the tapered tube. From Equation (3) above, it can be seen that the gas flow passing through the ion focusing guide 8 can be controlled by the shape of the gas-filled ion guide formed by the plurality of guide electrodes. In the mass spectrometer according to the present embodiment, the relationship of Equation (3) is useful for determining the diameter and the length of the ion passage path 802.

The ion focusing guide 8 can be used not only as a cell for CID but also as a cell for performing a dissociation method other than CID, for example, laser-induced dissociation. However, it is desirable that the ion dissociation method used here is not a time-consuming dissociation method such as a method utilizing an EDD (electron desorption/dissociation) interaction between a gas particle or a laser beam and an ion, but a method capable of rapidly dissociating an ion.

### <Configuration and Operation of Bunching Ion Guide>

As described above, ions ejected from the second LIT 4 of the dual LIT and having a very narrow mass-to-charge ratio width whose cross-sectional area decreases (and whose cross-sectional area shape is reshaped) by the ion focusing guide 8 are introduced into the bunching ion guide 5. The basic configuration and operation of the bunching ion guide 5 are disclosed in Patent Literatures 1, 2, and others.

As illustrated in FIG. 4A, in the mass spectrometer of the present embodiment, the bunching ion guide 5 includes a large number of electrode plates 501 (only some electrodes are denoted by reference numerals in FIG. 4A) disposed along the axis 101, and rod electrodes 502 extending in the direction of the axis 100. Two sets of electrode plates 501 are disposed in the X-axis direction with the axis 101 interposed between them, and two sets of rod electrodes 502 are disposed in the Y-axis direction with the axis 101 interposed between them. That is, the two sets of electrode plates 501 and the two sets of rod electrodes 502 have a multipole (quadrupole) structure around the axis 101. However, the present invention is not limited to this structure, and the rod electrode 502 may include a large number of electrode plates, or an electrode plate having a shape in which an opening is formed at the center such as an annular shape may be arrayed along the axis 101. In either case, an ion transport path 503 through which ions pass around the axis 101 is formed.

The orthogonal acceleration portion 61 of the orthogonal acceleration TOF analysis unit 6 is continuously provided at a latter stage of the bunching ion guide 5. As described above, the bunching ion guide 5 can be divided into the bunch forming portion 5A and the ion bunch transporting portion 5B along the axis 101. However, the boundary between the bunch forming portion 5A and the ion bunch transporting portion 5B is not strict.

A DC voltage for forming a potential well in the ion transport path 503 and an RF voltage for confining ions in the radial direction are applied to the electrode plates 501 and the rod electrodes 502 from the power supply unit 11. Furthermore, a DC voltage for forming a potential gradient that accelerates ions in their traveling direction may be applied to the electrode plate 501 and the rod electrode 502. The DC voltage and the RF voltage may be applied to only one of the electrode plates 501 and the rod electrodes 502. In the configuration of FIG. 4A, usually, a DC voltage for forming a potential well is applied to the electrode plate 501 divided into a large number of portions. On the other hand, regarding the RF voltage, an equivalent confining electric field is generated in the ion transport path 503 in a case where the RF voltage of two phases opposite in phase to each other is applied to the electrode plates 501 and the rod electrodes 502, and in a case where the RF voltage of a single phase having twice the amplitude is applied only to one of the electrode plates 501 and the rod electrodes 502. By providing an electrode on which a DC voltage or an RF voltage is not superimposed or an electrode on which both of the DC voltage and the RF voltage are not superimposed, it is possible to expect improvement in performance of subsequent TOF ejection of ions and cost reduction due to simplification of a power supply, which are desirable aspects.

FIG. 4(B)-(C) schematically illustrates a schematic potential distribution and ion states on the axis 101. In a region close to the outlet of the ion focusing guide 8, ions collide with gas molecules a plurality of times and are cooled to some extent. The ion group cooled to some extent may be introduced into the bunch forming portion 5A and subsequently cooled at that place. In the bunch forming portion 5A, as illustrated in FIG. 4(B), in the first stage, one ion group ejected from the ion focusing guide 8 is bunched in the bunch forming portion 5A, that is, an ion bunch is formed, and accommodated in one potential well formed by a voltage applied to the electrode plates 501 and the rod electrodes 502. As the voltage applied to the electrode plates 501 and the rod electrodes 502 changes with time, the potential well moves to the downstream side as illustrated in FIG. 4(C), so that the ion bunch accommodated in the potential well also moves.

The formation of the ion bunch and the accommodation of the ion bunch in the potential well in the bunch forming portion 5A are synchronized with the operation of the movement of the potential well to the downstream side along the axis 101 after the accommodation. This operation is also synchronized with the ion ejection operation from the second LIT 4. Therefore, the group of ions ejected from the second LIT 4 in one ejection operation and the product ions generated from the ions are bunched and accommodated in one potential well, and then the group of ions ejected from the second LIT 4 and the product ions generated from the ions are temporally accommodated in the potential well formed in the bunch forming portion 5A. Then, the ions are sequentially sent from the bunch forming portion 5A to the ion bunch transporting portion 5B.

The ion focusing guide 8 having the above-described ion funnel structure is a device in which the mass dependency of the ion passage efficiency is relatively small. However, in the vicinity of the ion outlet, an undesired pseudopotential is generated in the axial direction due to the reason that the interval between the guide electrodes 801 adjacent in the axial direction and the size of the ion passage opening are close to each other, the RF electric field due to the RF voltage applied to the electrode plate 501 of the bunching ion guide 5 in the latter stage is superimposed, and thus, an ion accumulation having mass dependence may be generated. This results in a decrease in ion passage efficiency. In addition, this action differs depending on the manner of applying the DC voltage and the RF voltage to the electrode plate 501 and the rod electrode 502.

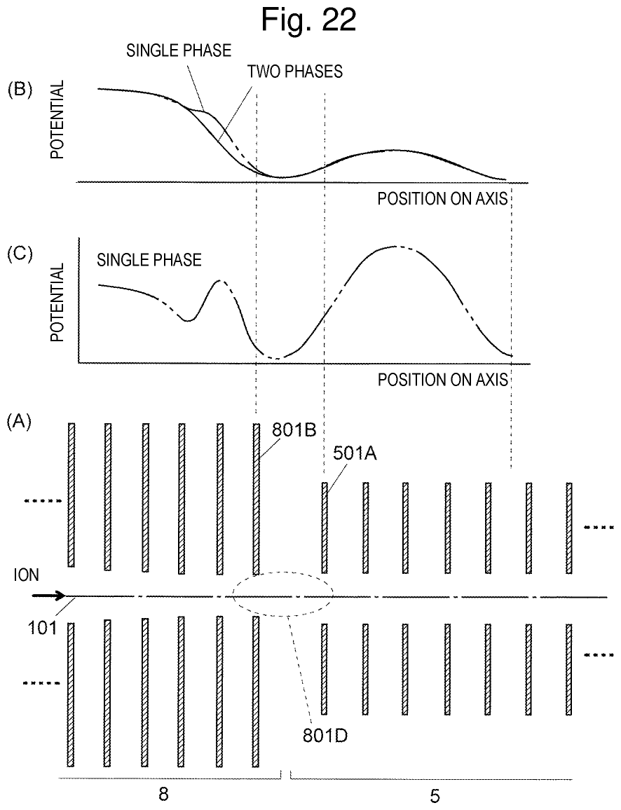

As one method for avoiding this, in the connection region between the ion focusing guide 8 and the bunching ion guide 5, that is, in a connection region 801D in the vicinity between an outlet-end guide electrode 801B of the ion passage path 802 and the electrode plate 501A at the foremost stage of the bunching ion guide 5 illustrated in FIG. 22(A), the DC voltage to be applied to each electrode may be adjusted so that the DC potential for the ions arriving from the ion upstream side is lowered. FIG. 22(C) is a diagram illustrating an example of the pseudopotential distribution on the axis 101 in a case where the DC potential is not adjusted, and FIG. 22(B) is a diagram illustrating an example of the pseudopotential distribution on the axis 101 in a case where the DC potential is appropriately adjusted. These are simulation results, and FIG. 22(C) is a calculation example at an RF voltage of a single phase. Of two lines in FIG. 22(B), the upper-side line is a calculation example at an RF voltage of a single phase, and the lower-side line is a calculation example at an RF voltage of two phases. As illustrated in FIG. 22, the potential barrier formed in front of the connection region 801D can be greatly lowered by adjusting the DC potential, and ions are easily transported from the ion focusing guide 8 to the bunching ion guide 5 regardless of the mass-to-charge ratio.

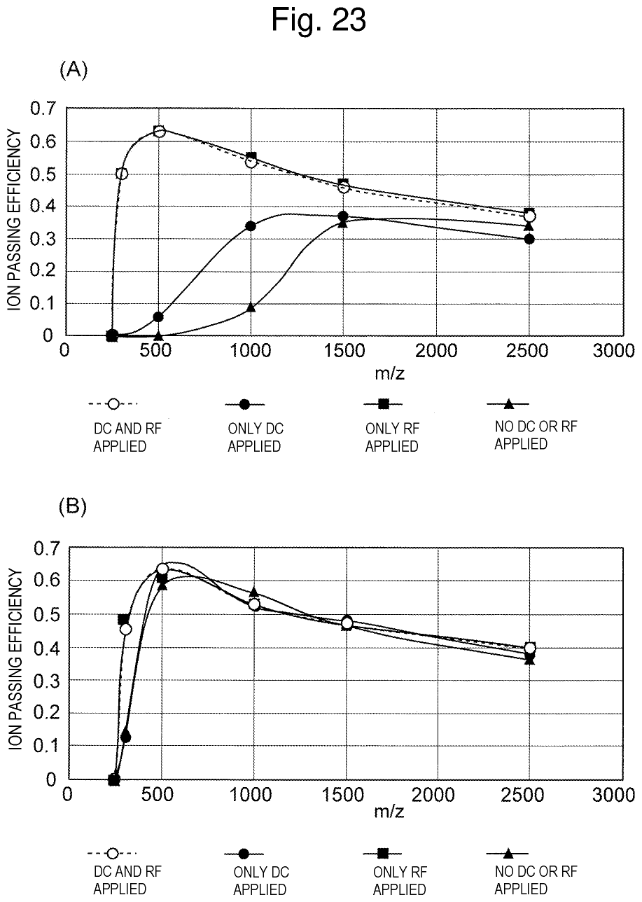

FIG. 23 includes diagrams illustrating results of calculating a relationship between a mass-to-charge ratio of ions and ion passage efficiency.

In the radio-frequency electric field of the bunching ion guide 5, as described in Patent Literature 1, the RF confinement potential and the transient DC collection potential are superimposed, so that bunching and convergence with respect to ions are performed. As described above, there are a plurality of methods for superimposing the RF confinement electric field and the DC convergence electric field. For example, in the case of the four-pole electrode configuration including the electrode plates 501 and the rod electrodes 502 illustrated in FIG. 4A, the DC voltage and the RF voltage of the same phase are supplied to the electrode pair facing in one direction. The following four methods are conceivable for supplying power to the electrode pair in the direction orthogonal to the above direction, and they are indicated by marks ∘, •, ▪, and ▴ in FIG. 23. That is, ∘ is a case where the DC voltage of the same phase and the RF voltage of the opposite phase are applied in a superimposed manner, • is a case where only the DC voltage of the same phase is applied and the RF voltage is not applied, ▪ is a case where only the RF voltage of the opposite phase is applied, and ▴ is a case where both the DC voltage and the RF voltage are not applied.

When the amplitudes of the DC voltage and the RF voltage are appropriately selected, the potential is equivalent to ions in the vicinity of the ion transport path 503 inside the bunching ion guide 5 in any of the above four application manners. However, at the end portion of the bunching ion guide 5, there is a difference in the influence of the four potentials on the ions due to the influence of the relative potential with respect to the adjacent ion focusing guide 8. As a result, at the joint portion between the bunching ion guide 5 and the ion focusing guide 8, as illustrated in FIG. 23(A), mass dependency appears in ion passage efficiency, which may cause a decrease in passing efficiency at a low mass. On the other hand, by appropriately selecting the relative potentials of the ion focusing guide 8 and the bunching ion guide 5, it is possible to sufficiently improve the mass dependence of the ion passage efficiency as illustrated in FIG. 23(B).

As described above, by appropriately adjusting the DC potential in the connection region 801D, the passage efficiency of ions can be improved over a wide mass-to-charge ratio.

As described above, the product ions generated by the ion dissociation in the ion focusing guide 8 move in the ion bunch transporting portion 5B of the bunching ion guide 5 in a state of being accommodated in one potential well together with the undissociated precursor ions, that is, as ions contained in the same ion bunch. During the ion dissociation operation and the movement of the ion bunch, ions accommodated in one potential well are not mixed with ions accommodated in another potential well adjacent along the axis 101. An ion bunch containing ions (precursor ions) ejected from the second LIT 4 at one time and product ions generated from the ions is accommodated in one potential well that has reached the orthogonal acceleration portion 61 in this manner. The orthogonal acceleration portion 61 accelerates the ions accommodated in the ion bunch contained in the one potential well substantially all at once in a direction substantially orthogonal to the axis 100 and inputs the ions into the flight space 62.

The moving speed of the potential well in the bunching ion guide 5 is synchronized with the repetition cycle of the ion ejection operation in the orthogonal acceleration unit 100, and all the ion bunches accommodated in the potential well sequentially sent are input from the orthogonal acceleration portion 61 into the flight space 62, and the mass spectrometry is executed. As a result, the mass spectrometer of the present embodiment can acquire, for each ion group ejected from the second LIT 4, mass spectrum data reflecting the amount of ions included in the ion group and product ions generated from the ions.

As described above, the mass-to-charge ratio width of ions ejected from the second LIT 4 at one time is, for example, 1 Da, which is considerably narrow. Therefore, unless ions derived from different compounds have the same mass-to-charge ratio or an extremely close mass-to-charge ratio, in many cases, it is possible to obtain mass spectrum data in which signal intensities of ions derived from one compound and product ions generated from the ions are observed. Therefore, data processing for deconvoluting complex mass spectrum data in which information of ions derived from a plurality of compounds is mixed becomes unnecessary, or such data processing becomes simpler than before.

As described above, in the mass spectrometer of the present embodiment, ions derived from the sample component continuously generated in the ion source 1 and product ions generated from the ions can be subjected to mass spectrometry with high duty cycle and high sensitivity, and a mass spectrum of high quality can be acquired. In particular, according to the mass spectrometer of the present embodiment, even when the number of components included in the sample is large, it is possible to collect the product ion information of each component with high completeness, so that the qualitative determination and quantification of each component can be performed with high accuracy, and the structural analysis can also be performed with high accuracy.

### [Verification by Simulation]

Next, simulation calculation performed to confirm the effect in the mass spectrometer of the present embodiment will be described.

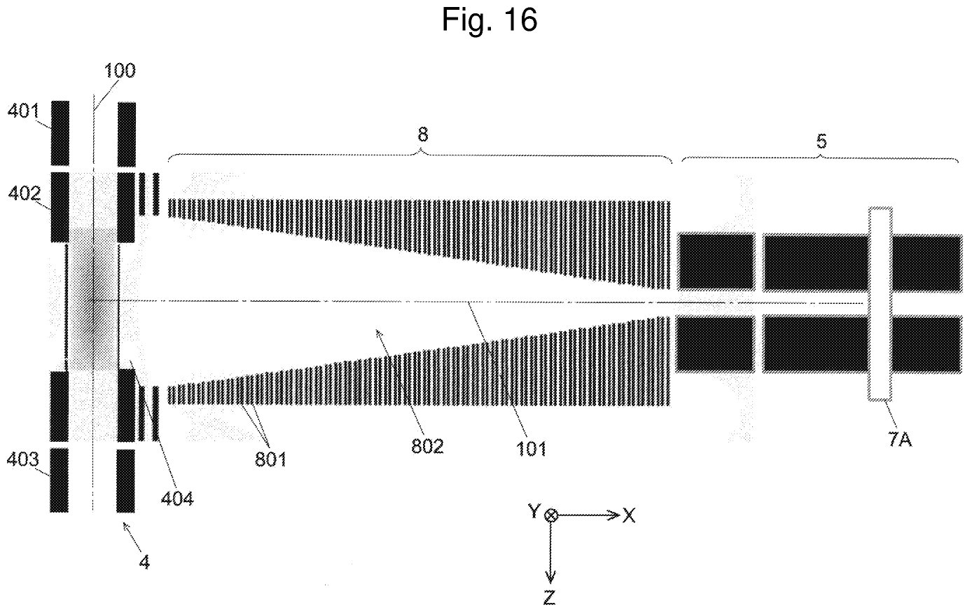

FIG. 16 is a configuration diagram of a model of an exemplary ion optical system used for simulation calculation. Since this ion optical system corresponds to the second LIT 4 and the ion focusing guide 8 illustrated in FIG. 2, the reference numerals of the corresponding parts used in FIG. 2 are used in the description of FIG. 16.

In this model, at the time of ion ejection from the second LIT 4, a single-phase rectangular wave-shaped RF voltage is applied to one rod electrode pair of two pairs of (four) rod electrodes included in the LIT 4, and a rectangular wave-shaped AC excitation voltage is applied to the other rod electrode pair (an electrode pair including the rod electrode provided with the ion ejection hole 404). The cycle of the AC excitation voltage is set to three times the period of the RF voltage, and is set at an ejection point of β=⅔ corresponding to an ejection q=0.61458 (Mathieu parameter). The second LIT 4 includes three portions in the direction of the axis 100, and the length of the central main rod portion 402 is 50 mm. The opening size of the ion ejection hole 404 is 0.8 mm in width and 30 mm in the axial length. Furthermore, in order to confine the ions trapped by the second LIT 4 in the space in the main rod portion 402, a predetermined DC voltage is applied to the pre-rod portion 401 and the post-rod portion 403.

As illustrated in FIG. 16, the ion focusing guide 8 is provided with a tapered ion passage path 802 formed of a plurality of guide electrodes 801 arrayed in the direction of the axis 101 of the ion focusing guide 8. Among the plurality of guide electrodes 801, the diameter of the inlet-end guide electrode 801A is 30 mm, and the diameter of the outlet-end guide electrode 801B is 5 mm. The length of the ion passage path 802 in the direction of the axis 101 is 150 mm. The interval between the guide electrodes 801 adjacent to each other in the direction of the axis 101 is 2 mm, and the thickness of each of the guide electrodes 801 is 0.2 mm. An alternating phase RF voltage is applied as an ion confinement RF voltage to each of the guide electrodes 801 adjacent in the direction of the axis 101, and the amplitude of the RF voltage is 50 V₀₋ₚ and the frequency is 1.5 MHz.

An argon gas is supplied to the ion passage path 802 as a buffer gas, and its gas pressure is uniform by 1 Pa over the entire ion passage path 802. This gas pressure is a value suitable for dissociating ions by CID. In addition, a DC voltage at which a DC potential gradient is linear along the axis 101 is applied to each guide electrode 801. The voltage difference between the ion inlet end and the outlet end is 90 V.

The bunch forming portion 5A of the bunching ion guide 5 includes four (two pairs of) quadrupole rod electrodes, and a pair of rod electrodes is divided into a plurality of parts in the direction of the axis 101. A single-phase RF voltage having an amplitude of 200V₀₋ₚ and a frequency of 1.5 MHz is applied to the undivided rod electrode pair. On the other hand, the thickness of one electrode plate of the divided rod electrodes is 0.2 mm, and the interval between the adjacent electrodes is 2 mm. That is, the thickness and the interval of the electrode plate are the same as those of the guide electrode 801 in the ion focusing guide 8.

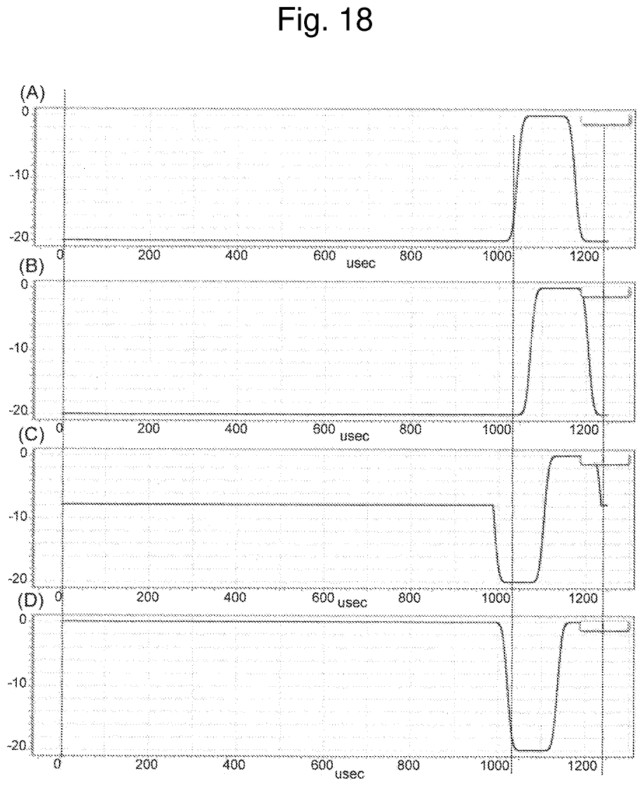

An eight-phase bunching AC voltage is applied to the pair of rod electrodes divided into a plurality of parts in the direction of the axis 101 in the bunch forming portion 5A. FIG. 18 illustrates voltage waveforms of four phases (first phase #1 to fourth phase #4) among the eight phases. FIG. 18(A) illustrates a bunching AC voltage waveform of the first phase #1. As illustrated in FIG. 18(A), in the bunching AC voltage, there are alternately a stop period in which the voltage value is at a low level and a transport period in which the voltage value is at a high level. The stop period lasts about 1 msec and the transport period lasts about 0.25 msec. FIGS. 18(B), (C), and (D) illustrates the bunching AC voltage waveforms of the second phase #2, the third phase #3, and the fourth phase #4, respectively. The gas introduced into the bunch forming portion 5A is argon gas, and its gas pressure is 10 Pa.

The ion bunch transporting portion 5B configured to continuously move the potential well is provided at a next stage of the bunch forming portion 5A. The frequency of the single-phase transport voltage used in the ion bunch transporting portion 5B is 4 kHz. As illustrated in FIG. 16, an ion detector 7A is disposed in the ion bunch transporting portion 5B so as to detect a plurality of translating ion bunches. The ion detector 7A is virtually provided for simulation (not present in an actual device), and does not affect the electric field of the ion bunch transporting portion 5B at all. Using the ion detector 7A, the present inventors performed simulation by measuring the amount of ions in the transported ion bunch and the temporal characteristics of the ions.

In the simulation calculation, a state in which two kinds of precursor ions having mass-to-charge ratios of 1000 Th and 1001 Th are initially present in the internal space 405 of the second LIT 4 was assumed. The time to equilibrate by contact with the buffer gas was given before these ions were resonantly ejected from the second LIT 4 by mass scan. As a result, as illustrated in FIG. 16, an ion cloud extending in the direction of the axis 100 is formed in the internal space 405 of the second LIT 4. In the subsequent mass scan, first, an ion group containing ions having a mass-to-charge ratio of 1000 Th is ejected from the second LIT 4 in the radial direction through the ion ejection hole 404, and enter the ion passage path 802 of the ion focusing guide 8. During the passage through the ion passage path 802, the ions contact the buffer gas, and product ions in the mass-to-charge ratio range of 100 to 1500 Th are generated by the CID. Then, in the bunch forming portion 5A of the bunching ion guide 5, a first ion bunch containing product ions generated from precursor ions having a mass-to-charge ratio of 1000 Th is formed.

As the mass scan progresses, an ion group containing ions having a mass-to-charge ratio of 1001 Th is then ejected in the radial direction from the second LIT 4 through the ion ejection hole 404. The ion group containing the ion of m/z 1001 Th is ejected with a delay of 1.25 msec from the ion group containing the ion of m/z 1000 Th. In the ion passage path 802 of the ion focusing guide 8, ions of m/z 1001 Th are dissociated by CID, product ions in the mass-to-charge ratio range of 100 to 1500 Th are generated, and the second ion bunch is formed in the bunch forming portion 5A. That is, the second ion bunch contains product ions generated from precursor ions with m/z 1001 Th.

The number of product ions contained in each ion bunch was determined to be the same as the number of precursor ions corresponding to each ion bunch. The axial energy of the ions contained in the first ion bunch and the second ion bunch is in the range of several eV to 1600 eV, and the average axial energy of the ions is 290 eV. For each of the first and second ion bunches formed in the ion passage path 802, the behavior of ions in the operation of accommodating ions in the potential well in the bunch forming portion 5A and the subsequent ion bunch transport operation in the ion bunch transporting portion 5B was simulated.

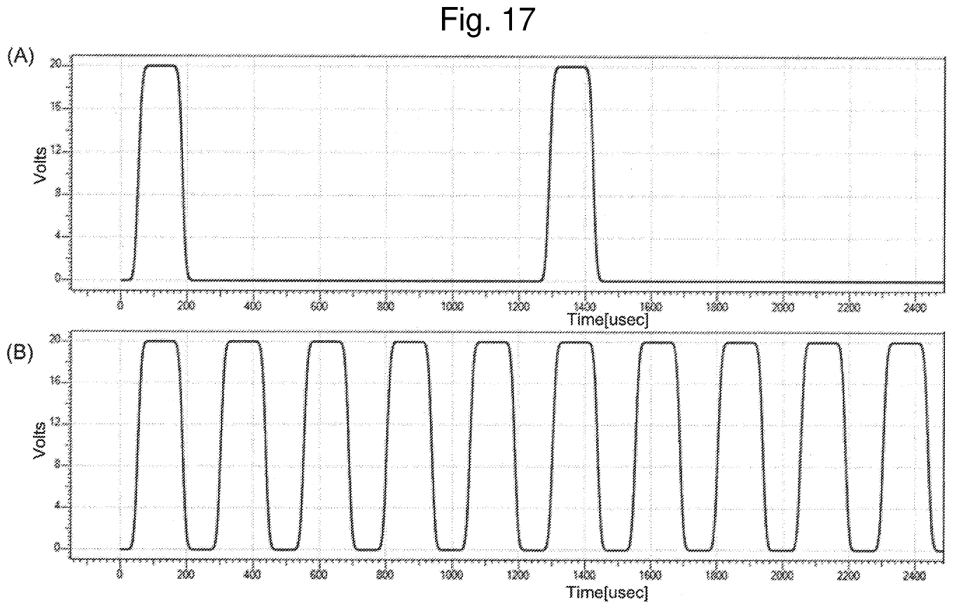

Representative voltage waveforms applied to the bunch forming portion 5A and the ion bunch transporting portion 5B are illustrated in FIG. 17. FIG. 17 illustrates a bunching AC voltage waveform (A) and a transport AC voltage waveform (B) having a phase synchronized with the bunching AC voltage waveform (A). By using these representative voltage waveforms, the ion bunch can be reliably trapped by the potential well, sent from the bunch forming portion 5A to the ion bunch transporting portion 5B, and transported in the ion bunch transporting portion 5B. The ion detector 7A detects ions contained in the first and second ion bunches.

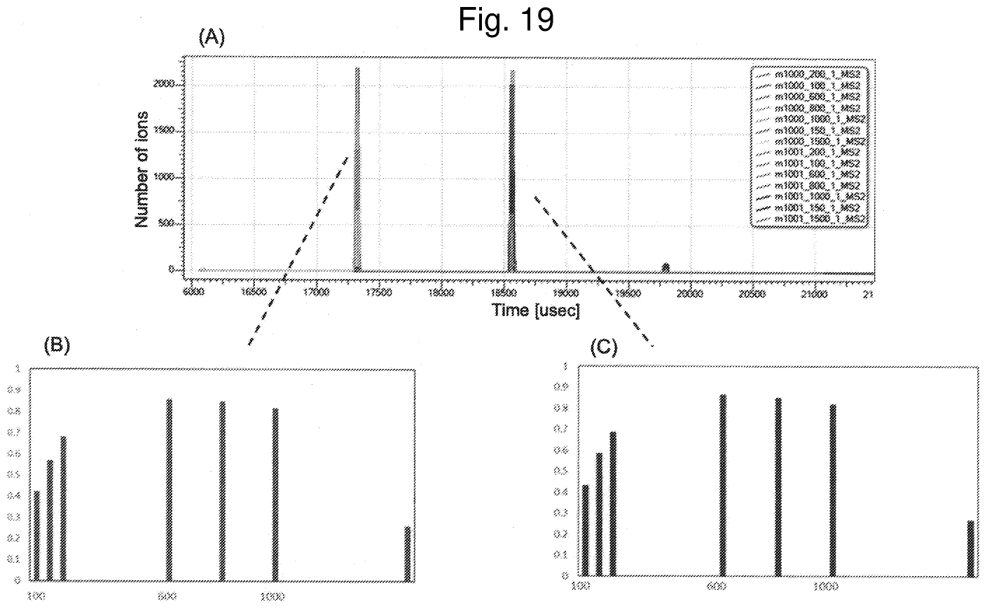

FIG. 19(A) is a graph illustrating a temporal change in the ionic intensity signal obtained by the ion detector 7A. From FIG. 19(A), it is possible to confirm that most of the ions contained in the first ion bunch are accommodated in one potential well and most of the ions contained in the second ion bunch are accommodated in another potential well. In FIG. 19, product ions corresponding to two different precursor ions are shown in different colors. The potential well in which the first ion bunch is accommodated is detected at a scan time of 17.3 msec.

At the time point of ion detection, each ion contained in the ion bunch is sufficiently cooled, and ions do not leak from the potential well to its outside. Since the buffer gas exists at an appropriate gas pressure in the ion bunch transporting portion 5B, the ions contained in the ion bunch continue to be cooled during the transport in the ion bunch transporting portion 5B. FIGS. 19(B)-(C) are mass spectra created on the basis of detection results of ions accommodated in two potential wells, respectively. The peak intensity of the mass spectrum obtained by this simulation calculation is normalized by the number of precursor ions enter the ion passage path 802. From this result, it can be seen that only precursor ions ejected from the second LIT 4 and product ions generated from the precursor ions are observed in each mass spectrum, that is, mixing of ions does not substantially occur.

The above simulation results indicate that the ion focusing guide 8 can appropriately trap ions in a wide energy range ejected from the second LIT 4 in the radial direction and that the bunch forming portion 5A can accurately pack the target ions into one ion bunch. Even when ions enter the bunch forming portion 5A, the mass resolution at the time of ion ejection from the second LIT 4 is maintained, and the operations of the bunch forming portion 5A and the ion bunch transporting portion 5B can be synchronized with the mass scan speed in the second LIT 4. This example shows that the ion focusing guide 8 functions as a collision cell which can not only provide precursor ions but also can dissociate the precursor ions to provide product ions having a wide mass-to-charge ratio range. In this example, product ion groups derived from two precursor ions separated in units of 1 Da as described above can be accommodated in two separate ion bunches and transported to the mass spectrometry unit without substantially causing mutual interference.

### Second Embodiment

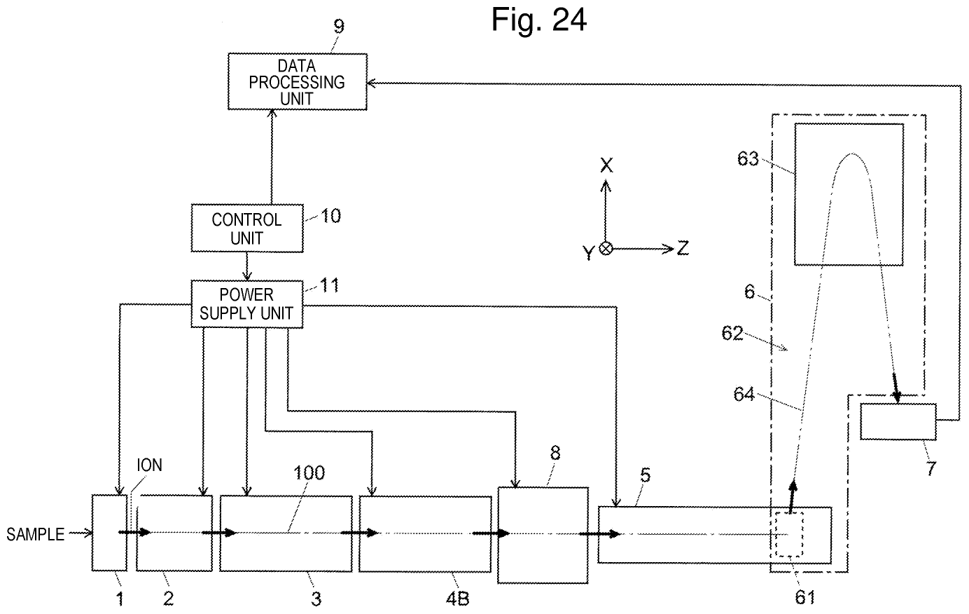

FIG. 24 is an overall configuration diagram of a second embodiment of a mass spectrometer according to the present invention. The same or corresponding components as those of the mass spectrometer of the first embodiment described in detail are denoted by the same reference numerals. A difference from the mass spectrometer of the first embodiment is that a second LIT 4B of the second stage of the dual LIT is not an LIT (MSRE-type LIT) that ejects ions in the radial direction orthogonal to the axis but an LIT (MSAE-type LIT) that mass-selectively ejects ions in the axial direction, similarly to the first LIT 3. Therefore, in this device, as is clear from FIG. 24, the ion source 1, the ion accumulation unit 2, the first LIT 3, the second LIT 4B, the ion focusing guide 8, and the bunching ion guide 5 are located on the substantially straight axis 100.

The ejection of ions from the second LIT 4B can be performed using resonant excitation such as single dipole AC excitation or multiple dipole AC excitation used for driving the first LIT 3, or other known methods. In the MSRE-type LIT, the variation in the axial direction of the starting position of the ions ejected at one time is substantially not a problem, but in the MSAE-type LIT, this may be a problem. Therefore, for example, it is conceivable as one method to reduce the influence of the variation in the axial position at the time of ion departure by using a relatively short second LIT 4B in the axial direction.

On the other hand, in the MSRE-type LIT, there is a concern that since the energy of the ejected ions is too large, it is difficult to trap the ions unless the RF electric field is strengthened by the ion focusing guide, or the ions may be finely fragmented due to collision with the residual gas. On the other hand, in the MSAE-type LIT, since the energy of the ejected ions is relatively small, there are advantages that the ions are easily trapped even when the RF electric field at the inlet end of the ion focusing guide is relatively weak, and fragmentation due to collision with the residual gas hardly occurs. In addition, in the MSAE-type LIT, the variation in the direction of the ejected ions tends to be large, but the ion focusing guide 8 having an ion funnel structure provided at the latter stage can appropriately gather the expanded ions, so that the influence of the spread of the ions can also be suppressed.

### Various Modifications

Modifications of the respective elements constituting the mass spectrometer have already been described. In addition, in the mass spectrometer of the first embodiment, the dual LIT in which the MSAE-type LIT and the MSRE-type LIT are combined is used, but a single MSRE-type LIT may be used instead of the dual LIT.

It should be noted that the previously described embodiments and their modifications are mere examples of the present invention. Any modification, change, or addition appropriately made within the spirit of the present invention will evidently fall within the scope of claims of the present application.

### Various Modes

A person skilled in the art can understand that the previously described illustrative embodiments are specific examples of the following modes of the present invention.

(Clause 1) One mode of a mass spectrometer according to the present invention is a mass spectrometer including:
a linear ion trap configured to trap ions derived from a sample in a trap space extending along a linear axis and eject a part of the ions from the trap space to the outside;
an ion guide unit configured to receive the ions ejected from the linear ion trap and deliver the ions to a latter stage, the ion guide unit including an ion inlet configured to receive the ejected ions, an ion outlet configured to send the received ions and/or ions generated from the received ions to a latter stage, and an ion passage path having a cross-sectional area decreasing as the ions travel from the ion inlet to the ion outlet;
a bunching unit configured to bunch the ions ejected from the ion outlet of the ion guide unit to form an ion bunch and to send the ion bunch to a downstream side; and
a mass spectrometry unit configured to separate and detect, according to a mass-to-charge ratio, ions contained in the ion bunch formed and sent by the bunching unit.

(Clause 2) In the mass spectrometer of Clause 1, the linear ion trap may be configured to trap the ions derived from the sample in the trap space extending along the linear axis and eject a part of the ions in a direction substantially orthogonal to the axis through an ejection hole having an elongated shape in a direction of the axis, and the ion guide unit is configured such that a size in a longitudinal direction of the ejection hole of an inlet-side cross section of the ion passage path is larger than a size in the longitudinal direction of the ejection hole of an outlet-side cross section of the ion passage path.

(Clause 3) In the mass spectrometer of Clause 1, the linear ion trap may be configured to trap the ions derived from the sample in the trap space extending along the linear axis and eject a part of the ions in a direction parallel to the axis through an ejection hole provided on the axis.

According to the mass spectrometer described in Clause 1 and Clause 2, it is possible to collect the ion group ejected in the radial direction from the linear ion trap and having the elongated cross-sectional shape more efficiently by the ion guide unit, that is, while suppressing ion loss, and to deliver the ions to the bunching unit.

According to the mass spectrometer described in Clause 1 and Clause 3, it is possible to collect the ion group ejected in the axial direction from the linear ion trap and traveling while relatively widely spreading more efficiently by the ion guide unit, that is, while suppressing ion loss, and to deliver the ions to the bunching unit.

(Clause 4) In the mass spectrometer described in Clause 1, the ion guide unit may include an ion dissociation portion configured to dissociate the ions to generate productions in a portion of the ion passage path.

According to a mass spectrometer described in Clause 4, the product ions generated from precursor ions ejected from the linear ion trap, or both the precursor ions and the product ions can be delivered to the bunching unit without waste. As a result, it is possible to acquire a mass spectrum with high purity in which only ions ejected from the linear ion trap and having a specific mass-to-charge ratio or included in a specific mass-to-charge ratio range and product ions derived from the ions are observed. As a result, it is possible to avoid complicated data processing such as deconvolute.

(Clause 5) In the mass spectrometer described in Clause 4, the ion dissociation portion may be a collision-induced dissociation portion configured to accelerate the ions ejected through the ejection hole and cause the ions to collide with gas to dissociate the ions by collision-induced dissociation.

Since collision-induced dissociation can dissociate ions without taking time, it is possible to subject the ions to mass spectrometry without delay. This can shorten the cycle of mass spectrometry and enhance the completeness of spectrometry.

(Clause 6) In the mass spectrometer described in Clause 1, a gradient of gas pressure along a traveling direction of the ions may be formed in at least a portion of the ion passage path of the ion guide unit.

(Clause 7) In the mass spectrometer described in Clause 6, the gradient of the gas pressure may be such that a gas pressure on a side of the ion inlet is lower than a gas pressure on a side of the ion outlet.

According to the mass spectrometers described in Clause 6 and Clause 7, it is possible to increase the ion dissociation efficiency in the ion guide unit and to keep the gas pressure in the linear ion trap low (high vacuum degree).

(Clause 8) In the mass spectrometer described in Clause 2, the linear ion trap may include two pairs of rod-shaped electrode pairs centered on the axis of the linear ion trap, and an ion ejection hole provided in at least one rod-shaped electrode of a first rod-shaped electrode pair which is one of the two pairs of rod-shaped electrode pairs, the linear ion trap being configured to be operable by single-phase RF drive in which an RF voltage is applied only to a second rod-shaped electrode pair which is another one of the two pairs of rod-shaped electrode pairs,
the mass spectrometer further including a control unit configured to operate the linear ion trap by the single-phase RF drive when the ions are ejected from the linear ion trap.

In the mass spectrometer according to Clause 8, when ions are ejected from the linear ion trap, an RF voltage for ion trapping is not applied to the rod electrode in which the ion ejection hole is formed among the plurality of rod electrodes constituting the linear ion trap. Therefore, according to the mass spectrometer described in Clause 8, the ejected ions are less likely to be affected by the RF electric field, and the ions are efficiently introduced into the ion guide unit. As a result, it is possible to reduce the loss of ions and improve the spectrometry sensitivity.

(Clause 9) In the mass spectrometer described in Clause 8, the linear ion trap may be configured to be switchable between the single-phase RF drive in which the RF voltage is applied only to the second rod-shaped electrode pair and two-phase RF drive in which the RF voltage of opposite phases is applied to each of the first rod-shaped electrode pair and the second rod-shaped electrode pair, and
the control unit may be configured to operate the linear ion trap by the single-phase RF drive when the ions are ejected from the linear ion trap, and to operate the linear ion trap by the two-phase RF drive when the ions are introduced into the linear ion trap.

In the mass spectrometer described in Clause 9, when ions are introduced from the outside into the linear ion trap, since a general quadrupole RF electric field is formed in the linear ion trap, the ions are introduced into the linear ion trap satisfactorily, that is, substantially without loss. On the other hand, when ions are ejected from the linear ion trap, since an RF voltage for ion trapping is not applied to the rod electrode in which the ion ejection hole is formed, the ejected ion are introduced into the ion guide unit satisfactorily. Thus, according to the mass spectrometer described in Clause 9, it is possible to perform both the introduction of ions into the linear ion trap and the ion ejection from the linear ion trap satisfactorily, that is, efficiently.

(Clause 10) In the mass spectrometer described in Clause 9, an amplitude of the RF voltage applied to the second rod electrode pair in the single-phase RF drive may be twice as large as an amplitude of the RF voltage applied in the two-phase RF drive.

According to the mass spectrometer described in Clause 10, the RF electric field formed in the linear ion trap during the single-phase RF drive and during the two-phase RF drive are substantially the same for ions. As a result, it is possible to avoid loss of ions due to an undesired behavior at the time of switching between the single-phase RF drive and the two-phase RF drive.

(Clause 11) In the mass spectrometer according to any one of Clause 8 to Clause 10, the linear ion trap may further include a shield electrode for reducing an influence of an electric field caused by the RF voltage applied to the second rod electrode pair in the single-phase RF drive on operation of ions in an ion optical system located downstream of the electric field.

According to the mass spectrometer described in Clause 11, it is possible to further reduce the influence of the RF electric field on the ions ejected from the linear ion trap and to introduce the ions more efficiently into the ion guide unit located on the downstream side.

(Clause 12) In the mass spectrometer described in Clause 1, the ion guide unit may include a plurality of annular electrodes arranged along a traveling direction of the ions, and the ion passage path is formed in openings of the plurality of annular electrodes.

According to the mass spectrometer described in Clause 12, it is possible to form, in the ion passage path, an electric field which appropriately captures ions and gradually forces the ions to approach to the axis. This enables efficient transportation of ions and focusing of the ions.

(Clause 13) The mass spectrometer according to Clause 12 may be a mass spectrometer further including a voltage application unit configured to apply voltages to the plurality of annular electrodes so that a potential gradient is formed in a passage direction of the ions.

According to the mass spectrometer described in Clause 13, the potential gradient formed in the ion passage path can accelerate the ions and apply large collision energy to the ions to dissociate the ions by collision-induced dissociation, or, on the other hand, can decelerate ions having large energy and send the ions into the bunching unit.

(Clause 14) In the mass spectrometer according to any one of Clause 1 to Clause 13,
the bunching unit may include a bunch collection region in which the ions received from the ion guide unit are collected to form an ion bunch, the bunching unit being configured to accommodate the ion bunch formed in the bunch collection region in an ion-trapping potential well moving in a traveling direction of the ions and cause the ion bunch to move, and
the mass spectrometry unit may be a time-of-flight mass spectrometry unit configured to introduce the ions contained in the ion bunch accommodated in the ion-trapping potential well that has moved in the bunching unit into a flight space, and separate and detect the ions according to a mass-to-charge ratio.

According to the mass spectrometer described in Clause 14, it is possible to perform mass spectrometry with clearly distinguishing ions ejected from the linear ion trap at a certain time point and/or product ions generated from the ions from ions ejected from the linear ion trap at another time point and/or product ions generated from the ions. Accordingly, there is a high possibility that a highly pure MS2 spectrum reflecting only precursor ions and product ions derived from one compound can be acquired. As a result, it is possible to avoid an operation of convoluting a complex MS2 spectrum in which product ions derived from different types of precursor ions are mixed, and it is possible to reduce a load of data processing.

(Clause 15) In the mass spectrometer according to any one of Clause 1 to Clause 14,
the linear ion trap may be set as a second linear ion trap, and
a first linear ion trap may be disposed in a preceding stage of the second linear ion trap, the first linear trap including a plurality of electrodes disposed along an axis and being configured to trap the ions derived from the sample in the trap space surrounded by the plurality of electrodes and eject, in a direction of the axis, the ions in a predetermined first mass-to-charge ratio width among the ions trapped, the second linear ion trap being configured to trap the ions ejected from the first linear ion trap in the trap space surrounded by the plurality of electrodes and eject the ions in a second mass-to-charge ratio width narrower than the first mass-to-charge ratio width among the ions trapped,
the mass spectrometer further including a control unit configured to drive the first linear ion trap and the second linear ion trap to synchronize an ejection operation from the first linear ion trap and an ejection operation from the second linear ion trap and supply the ions from the first linear ion trap to the second linear ion trap before all of the ions trapped in the second linear ion trap are ejected.

In the mass spectrometer described in Clause 15, for example, ions generated from a sample in an ion source or the like are temporarily accumulated in an axial ejection-type first linear ion trap, and the accumulated ions in a predetermined mass-to-charge ratio range are ejected in the axial direction for each first mass-to-charge ratio width. Then, almost all the ions ejected from the first linear ion trap are temporarily trapped in the second linear ion trap. In the second linear ion trap, the trapped ions are ejected for each second mass-to-charge ratio width, and sent to the ion guide unit and the bunching unit. In addition, the operation of transferring ions from the first linear ion trap to the second linear ion trap and the operation of ejecting ions from the second linear ion trap are performed synchronously, and ions are replenished from the first linear ion trap so that ions ejected from the second linear ion trap do not substantially disappear. Therefore, except for the loss of ions during transfer, ions generated from the sample are not wastefully discarded, and most of the ions are used for spectrometry or subjected to an ion dissociation operation.

In this way, according to the mass spectrometer described in Clause 15, the ion utilization efficiency and the duty cycle can be further improved, and the sensitivity of the spectrometry can be improved while ensuring the completeness of the spectrometry.

(Clause 16) In the mass spectrometer described in Clause 15, the control unit may be configured to supply the ions in the first mass-to-charge ratio width from the first linear ion trap to the second linear ion trap every time the ions in the second mass-to-charge ratio width are ejected one or more times from the second linear ion trap.

According to the mass spectrometer described in Clause 16, ions are always trapped in the second linear ion trap at the time point when the ions are to be ejected from the second linear ion trap. Thus, for example, during mass scan, it is possible to repeatedly eject ions in the second mass-to-charge ratio width from the second linear ion trap at a predetermined timing and subject the ions to mass spectrometry.

(Clause 17) In the mass spectrometer described in Clause 15, the control unit may be configured to drive the first linear ion trap and the second linear ion trap such that a speed at which a mass-to-charge ratio of the ions ejected from the first linear ion trap is changed and a speed at which a mass-to-charge ratio of the ions ejected from the second linear ion trap is changed are the same.

According to the mass spectrometer described in Clause 17, since the scan speeds of the first linear ion trap and the second linear ion trap coincide with each other at the time of simultaneous mass scan, control is easy. In addition, in simultaneous mass scan, it is easy to keep a difference between the mass-to-charge ratio of ions ejected from the first linear ion trap and the mass-to-charge ratio of ions ejected from the second linear ion trap constant.

(Clause 18) In the mass spectrometer described in Clause 15, the first linear ion trap may include, on an outlet side along the axis, a post-rod portion including a plurality of rod-shaped electrodes disposed so as to surround the axis,
the post-rod portion may be configured to form a barrier potential suppressing leakage of the ions from the trap space of the first linear ion trap, and
the control unit may be configured to apply a resonant excitation voltage exciting ions in a radial direction to the first linear ion trap, and to drive the first linear ion trap such that the ions having a predetermined mass-to-charge ratio trapped in the first linear ion trap are ejected beyond the barrier potential formed in the post-rod portion.

According to the mass spectrometer described in Clause 18, it is possible to transfer ions from the first linear ion trap to the second linear ion trap without being affected by an edge electric field generated by an aperture electrode or a grid electrode generally provided between the first linear ion trap and the second linear ion trap. As a result, it is possible to substantially eliminate or reduce the loss of ions due to the influence of the edge electric field, and to increase ion transfer efficiency to improve the spectrometry sensitivity.

(Clause 19) In the mass spectrometer described in Clause 15, the control unit may be configured to drive the first linear ion trap and the second linear ion trap such that a difference between a mass-to-charge ratio of the ions ejected from the first linear ion trap and a mass-to-charge ratio of the ions ejected from the second linear ion trap becomes substantially constant.

In the mass spectrometer described in Clause 19, it is possible to keep constant the difference between the mass-to-charge ratio of the ions ejected from the first linear ion trap and the mass-to-charge ratio of the ions ejected from the second linear ion trap, that is, the mass offset. As a result, it is not necessary to make the mass-to-charge ratio range of ions trapped in the second linear ion trap wider than necessary, and it is possible to trap a larger amount of ions having the same mass-to-charge ratio. As a result, according to the mass spectrometer described in Clause 19, it is possible to sufficiently exhibit the performance of the linear ion trap to improve the spectrometry sensitivity.

(Clause 20) In the mass spectrometer described in Clause 15, the control unit may be configured to apply a plurality of resonant excitation voltages having different mass-to-charge ratios of the ions to be resonantly excited to the first linear ion trap when the ions are ejected from the first linear ion trap.

(Clause 21) In the mass spectrometer described in Clause 20, the plurality of resonant excitation voltages may be voltages having different frequencies.

(Clause 22) In the mass spectrometer described in Clause 20 or Clause 21, the plurality of resonant excitation voltages may be determined such that widths of a plurality of mass-to-charge ratios of the ions simultaneously resonantly excited by the plurality of resonant excitation voltages are smaller than the first mass-to-charge ratio width.

In the mass spectrometer according to any one of Clause 20 to Clause 22, an ion species having a certain mass-to-charge ratio is repeatedly resonantly excited a plurality of times during mass scan, and is ejected from the first linear ion trap every time the ion species is excited. Therefore, even in a case where a part of the ions remains in the linear ion trap without being ejected from the first linear ion trap by one resonant excitation, the remaining ions are resonantly excited by the resonant excitation performed immediately after the resonant excitation. In this manner, according to the mass spectrometer described in any one of Clause 20 to Clause 22, it is possible to improve the efficiency of ion ejection from the first linear ion trap, and to increase the amount of ions to be subjected to mass spectrometry to improve the spectrometry sensitivity.

(Clause 23) In the mass spectrometer described in Clause 2, the linear ion trap may have a plurality of rod-shaped electrodes around the axis of the linear ion trap, and the ejection hole may be formed in one of the plurality of rod-shaped electrodes, and
the ion guide unit may be disposed such that the ion inlet of the ion guide unit protrudes from an outside of one rod-shaped electrode in which the ejection hole is formed to an inside of the rod-shaped electrode.

In the mass spectrometer described in Clause 23, even when the thickness of the rod-shaped electrode constituting the linear ion trap in the ion passage direction is large, it is possible to bring the ion inlet of the ion guide unit close to the ejection hole of the linear ion trap. As a result, it is possible to efficiently introduce ions ejected from the linear ion trap through the ejection hole into the ion guide unit to improve the ion detection sensitivity.

(Clause 24) In the mass spectrometer described in Clause 23, the ion guide unit may include a plurality of annular electrodes arranged along a traveling direction of the ions, and an opening of the plurality of annular electrodes may have an elliptical shape having a major axis in a longitudinal direction of the ejection hole or a rectangular shape elongated in the longitudinal direction and having a rounded corner.

According to the mass spectrometer described in Clause 24, it is possible to efficiently, that is, while suppressing a loss, transport an ion group ejected from the linear ion trap in the radial direction and having an elongated cross-sectional shape to the latter stage.

(Clause 25) In the mass spectrometer described in Clause 5, the ion dissociation portion may be provided on a downstream side of the ion passage path, and a housing in which the ion guide unit is disposed may have a gas vent opening for discharging a gas inside the housing at a position corresponding to an upstream side of the ion passage path.

While it is necessary to introduce a gas having a pressure sufficient to cause collision-induced dissociation into the ion dissociation portion, it is necessary to maintain a high degree of vacuum in order to separate ions with high mass resolution in the linear ion trap. On the other hand, in the mass spectrometer described in Clause 25, although the gas introduced into the ion dissociation portion is directed to the upstream side of the ion passage path having a lower gas pressure, most of the gas is discharged to the outside through the breathing opening formed in the housing. This makes it possible to reduce the amount of gas flowing into the linear ion trap and increase the degree of vacuum in the linear ion trap while maintaining a gas pressure sufficient to cause collision-induced dissociation in the ion dissociation portion. In addition, since it is not necessary to make the area of the ejection hole smaller than necessary in order to reduce the amount of gas flowing into the linear ion trap, it is possible to increase the extraction efficiency of ions from the linear ion trap.

(Clause 26) In the mass spectrometer described in Clause 12, a mass spectrometer may further include a voltage application unit configured to apply a predetermined DC voltage to at least a part of electrodes constituting the ion guide unit and/or at least a part of the electrodes constituting the bunching unit so that a DC potential is lower in a connection region between the ion outlet of the ion guide unit and an ion inlet of the bunching unit than in a preceding stage of the connection region.

In the configuration in which the plurality of annular electrodes are arranged in the traveling direction of the ions, RF voltages having phases opposite to each other are typically applied to the electrodes adjacent in the traveling direction of the ions, but in a region where the opening area in the vicinity of the ion outlet is small, a pseudopotential barrier is easily formed by the RF voltage and the RF voltage applied to the bunching unit. On the other hand, in the mass spectrometer described in Clause 26, it is possible to reduce the influence of the pseudopotential barrier by lowering the DC potential in the connection region, and to improve the ion passage efficiency for ions having a wide mass-to-charge ratio. As a result, highly sensitive spectrometry is achieved for ions of a wide mass-to-charge ratio.

### REFERENCE SIGNS LIST

1 . . . Ion Source
2 . . . Ion Accumulation Unit
20, 21, 22 Chamber
213, 214, 217, 218 . . . Gas Tube
215, 216, 219 . . . Exhaust Tube
3 . . . First Linear Ion Trap (LIT)
301 . . . Main Rod Portion
302 . . . Post-Rod Portion
303 . . . Internal Space
4, 4B . . . Second Linear Ion Trap (LIT)
401 . . . Pre-Rod Portion
402 . . . Main Rod Portion
4021, 4022, 4023, 4024 . . . Rod Electrode
403 . . . Post-Rod Portion
404 . . . Ion Ejection Hole
405 . . . Internal Space
406 . . . Shield Electrode
5 . . . Bunching Ion Guide
501 . . . Electrode Plate
502 . . . Rod Electrode
503 . . . Ion Transport Path
5A . . . Bunch Forming Portion
5B . . . Ion Bunch Transporting Portion
6 . . . Orthogonal Acceleration TOF Analysis Unit
61 . . . Orthogonal Acceleration portion
62 . . . Flight Space
63 . . . Ion Reflection Portion
64 . . . Flight Trajectory
7 . . . Ion Detection Unit
8 . . . Ion Focusing Guide
801 . . . Guide Electrode
802 . . . Ion Passage Path
830 . . . Shielding Portion
9 . . . Data Processing Unit
10 . . . Control Unit
11 . . . Power Supply Unit
110 . . . RF Power Supply
1101, 1102, 1103, 112 . . . Switch
1104, 1105 . . . Output Terminal
112 . . . AC Power Supply
100, 101 . . . Axis (Ion Optical Axis)

1. A mass spectrometer comprising:
a linear ion trap configured to trap ions derived from a sample in a trap space extending along a linear axis and eject a part of the ions from the trap space to an outside;
an ion guide unit configured to receive the ions ejected from the linear ion trap and deliver the ions to a latter stage, the ion guide unit including an ion inlet configured to receive the ejected ions, an ion outlet configured to send the received ions and/or ions generated from the received ions to a latter stage, and an ion passage path having a cross-sectional area decreasing as the ions travel from the ion inlet to the ion outlet;
a bunching unit configured to bunch the ions ejected from the ion outlet of the ion guide unit to form an ion bunch and to send the ion bunch to a downstream side; and
a mass spectrometry unit configured to separate and detect, according to a mass-to-charge ratio, ions contained in the ion bunch formed and sent by the bunching unit.

2. The mass spectrometer according to claim 1, wherein the linear ion trap is configured to trap the ions derived from the sample in the trap space extending along the linear axis and eject a part of the ions in a direction substantially orthogonal to the axis through an ejection hole having an elongated shape in a direction of the axis, and the ion guide unit is configured such that a size in a longitudinal direction of the ejection hole of an inlet-side cross section of the ion passage path is larger than a size in the longitudinal direction of the ejection hole of an outlet-side cross section of the ion passage path.

3. The mass spectrometer according to claim 1, wherein the linear ion trap is configured to trap the ions derived from the sample in the trap space extending along the linear axis and eject a part of the ions in a direction parallel to the axis through an ejection hole provided on the axis.

4. The mass spectrometer according to claim 1, wherein the ion guide unit includes an ion dissociation portion configured to dissociate the ions to generate product ions in a portion of the ion passage path.

5. The mass spectrometer according to claim 4, wherein the ion dissociation portion is a collision-induced dissociation portion configured to accelerate the ions ejected through the ejection hole and cause the ions to collide with gas to dissociate the ions by collision-induced dissociation.

6. The mass spectrometer according to claim 1, wherein a gradient of gas pressure along a traveling direction of the ions is formed in at least a portion of the ion passage path of the ion guide unit.

7. (canceled)

8. The mass spectrometer according to claim 2, wherein
the linear ion trap includes two pairs of rod-shaped electrode pairs centered on the axis of the linear ion trap, and an ion ejection hole provided in at least one rod-shaped electrode of a first rod-shaped electrode pair which is one of the two pairs of rod-shaped electrode pairs, the linear ion trap being configured to be operable by single-phase RF drive in which an RF voltage is applied only to a second rod-shaped electrode pair which is another one of the two pairs of rod-shaped electrode pairs,
the mass spectrometer further comprising a control unit configured to operate the linear ion trap by the single-phase RF drive when the ions are ejected from the linear ion trap.

9. The mass spectrometer according to claim 8, wherein
the linear ion trap is configured to be switchable between the single-phase RF drive in which the RF voltage is applied only to the second rod-shaped electrode pair and two-phase RF drive in which the RF voltage of opposite phases is applied to each of the first rod-shaped electrode pair and the second rod-shaped electrode pair, and
the control unit is configured to operate the linear ion trap by the single-phase RF drive when the ions are ejected from the linear ion trap, and to operate the linear ion trap by the two-phase RF drive when the ions are introduced into the linear ion trap.

10-11. (canceled)

12. The mass spectrometer according to claim 1, wherein the ion guide unit includes a plurality of annular electrodes arranged along a traveling direction of the ions, and the ion passage path is formed in openings of the plurality of annular electrodes.

13. The mass spectrometer according to claim 12, further comprising a voltage application unit configured to apply a voltage to the plurality of annular electrodes so that a potential gradient is formed in a passage direction of the ions.

14. The mass spectrometer according to claim 1, wherein
the bunching unit includes a bunch collection region in which the ions received from the ion guide unit are collected to form an ion bunch, the bunching unit being configured to accommodate the ion bunch formed in the bunch collection region in an ion-trapping potential well moving in a traveling direction of the ions and cause the ion bunch to move, and
the mass spectrometry unit is a time-of-flight mass spectrometry unit configured to introduce the ions contained in the ion bunch accommodated in the ion-trapping potential well that has moved in the bunching unit into a flight space, and separate and detect the ions according to a mass-to-charge ratio.

15. The mass spectrometer according to claim 1, wherein
the linear ion trap is set as a second linear ion trap, and
a first linear ion trap is disposed in a preceding stage of the second linear ion trap, the first linear trap including a plurality of electrodes disposed along an axis and being configured to trap the ions derived from the sample in the trap space surrounded by the plurality of electrodes and eject, in a direction of the axis, the ions in a predetermined first mass-to-charge ratio width among the ions trapped, the second linear ion trap being configured to trap the ions ejected from the first linear ion trap in the trap space surrounded by the plurality of electrodes and eject the ions in a second mass-to-charge ratio width narrower than the first mass-to-charge ratio width among the ions trapped,
the mass spectrometer further comprising a control unit configured to drive the first linear ion trap and the second linear ion trap to synchronize an ejection operation from the first linear ion trap and an ejection operation from the second linear ion trap and supply the ions from the first linear ion trap to the second linear ion trap before all of the ions trapped in the second linear ion trap are ejected.

16. The mass spectrometer according to claim 15, wherein the control unit is configured to supply the ions in the first mass-to-charge ratio width from the first linear ion trap to the second linear ion trap every time the ions in the second mass-to-charge ratio width are ejected one or more times from the second linear ion trap.

17. (canceled)

18. The mass spectrometer according to claim 15, wherein
the first linear ion trap includes, on an outlet side along the axis, a post-rod portion including a plurality of rod-shaped electrodes disposed so as to surround the axis,
the post-rod portion is configured to form a barrier potential suppressing leakage of the ions from the trap space of the first linear ion trap, and
the control unit is configured to apply a resonant excitation voltage exciting ions in a radial direction to the first linear ion trap, and to drive the first linear ion trap such that the ions having a predetermined mass-to-charge ratio trapped in the first linear ion trap are ejected beyond the barrier potential formed in the post-rod portion.

19. The mass spectrometer according to claim 15, wherein the control unit is configured to drive the first linear ion trap and the second linear ion trap such that a difference between a mass-to-charge ratio of the ions ejected from the first linear ion trap and a mass-to-charge ratio of the ions ejected from the second linear ion trap becomes substantially constant.

20. The mass spectrometer according to claim 15, wherein the control unit is configured to apply a plurality of resonant excitation voltages having different mass-to-charge ratios of the ions to be resonantly excited to the first linear ion trap when the ions are ejected from the first linear ion trap.

21. (canceled)

22. The mass spectrometer according to claim 20, wherein the plurality of resonant excitation voltages are determined such that widths of a plurality of mass-to-charge ratios of the ions simultaneously resonantly excited by the plurality of resonant excitation voltages are smaller than the first mass-to-charge ratio width.

23. The mass spectrometer according to claim 2, wherein
the linear ion trap has a plurality of rod-shaped electrodes around the axis of the linear ion trap, and the ejection hole is formed in one of the plurality of rod-shaped electrodes, and
the ion guide unit is disposed such that the ion inlet of the ion guide unit protrudes from an outside of one rod-shaped electrode in which the ejection hole is formed to an inside of the rod-shaped electrode.

24. The mass spectrometer according to claim 23, wherein the ion guide unit includes a plurality of annular electrodes arranged along a traveling direction of the ions, and an opening of the plurality of annular electrodes has an elliptical shape having a major axis in a longitudinal direction of the ejection hole or a rectangular shape elongated in the longitudinal direction and having a rounded corner.

25. The mass spectrometer according to claim 5, wherein the ion dissociation portion is provided on a downstream side of the ion passage path, and a housing in which the ion guide unit is disposed has a gas vent opening for discharging a gas inside the housing at a position corresponding to an upstream side of the ion passage path.

26. The mass spectrometer according to claim 12, further comprising a voltage application unit configured to apply a predetermined DC voltage to at least a part of the electrodes constituting the ion guide unit and/or at least a part of electrodes constituting the bunching unit so that a DC potential is lower in a connection region between the ion outlet of the ion guide unit and an ion inlet of the bunching unit than in a preceding stage of the connection region.
